(19) United States
(12) Patent Application Publication
(10) Pub. No.: US 2025/0368760 A1
(43) Pub. Date: Dec. 4, 2025

(54) Constrained Geometry Metal-Ligand Complexes and Use Thereof in Olefin Polymerization

(71) Applicant: EXXONMOBIL CHEMICAL PATENTS INC., Baytown, TX (US)

(72) Inventors: Gursu Culcu, Humble, TX (US); David A. Cano, Houston, TX (US); Laughlin G. McCullough, League City, TX (US)

(21) Appl. No.: 18/874,994

(22) PCT Filed: Jun. 14, 2023
(86) PCT No.: PCT/US2023/068400

§ 371 Date: Dec. 13, 2024

Related U.S. Application Data
(60) Provisional application No. 63/355,249, filed on Jun. 24, 2022.

(51) Int. Cl. C08F 4/78; C07F 17/00; C08F 4/76

(52) U.S. Cl. CPC C08F 4/78; C07F 17/00; C08F 4/76

(57) ABSTRACT

Metal-ligand complexes may comprise a transition metal atom or a lanthanide metal atom and a ligand having a structure represented by Formula 1

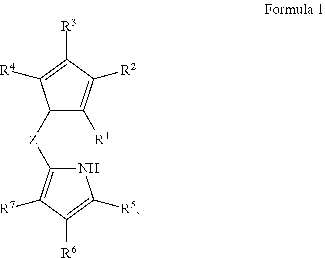

in which R¹, R², R⁵, and R⁶ are independently hydrogen or C₁-C₁₄ hydrocarbyl; R³ and R⁴ are independently hydrogen or C₁-C₁₄ hydrocarbyl, or R³ and R⁴ are joined together to form an optionally substituted 6-membered aromatic ring; R⁵ is hydrogen, C₁-C₁₀ alkyl, C₃-C₁₀ cycloalkyl, C₆-C₃₀ aryl, a heteroaryl group, or CN, provided that R⁵ is C₃-C₁₀ cycloalkyl, C₆-C₃₀ aryl, a heteroaryl group, or CN if the transition metal atom is Ti or Zr and R³ and R⁴ are joined together to form an optionally substituted 6-membered aromatic ring, or if the transition metal atom is Ti or Zr and R¹-R⁴ are all H; and Z is a bridging atom. Catalyst systems may comprise at least one activator and one or more metal-ligand complexes.

### CROSS REFERENCE TO RELATED APPLICATIONS

This application claims the benefit of and priority to U.S. Provisional Application No. 63/355,249 filed Jun. 24, 2022, the disclosure of which is incorporated herein by reference.

### FIELD

The present disclosure relates to olefin polymerization and metal-ligand complexes having a constrained geometry for use in olefin polymerization.

### BACKGROUND

A number of catalysts have been developed for polymerizing olefins, many of which are based upon metal-ligand complexes. The choice of catalyst may allow tailoring of various polyolefin properties, such as molecular weight, branching, tacticity, crystallinity, melt index, and similar features. Activators such as alumoxanes and non-coordinating anion activators are commonly used in conjunction with the metal-ligand complexes for promoting polymerization.

Metal-ligand complexes having a constrained geometry may be used for promoting olefin polymerization. Some of these metal-ligand complexes may include a π-bonding ligand bridged to a second ligand, which are each bonded to a metal atom in at least a bidentate fashion. Additional ligands may complete the coordination sphere of the metal atom. The bridge between the π-bonding ligand and the second ligand can create a relatively small angle (bite angle) between the π-bonding ligand and the second ligand. The relatively small angle can provide a more active catalyst platform than may be present in other catalyst systems, such as Ziegler-Natta catalysts, unbridged metallocenes, and other single-site catalysts. Representative metal-ligand complexes having a constrained geometry by virtue of a one-atom bridge between a π-bonding ligand and a pyrrole ligand are described in CN112552436, CN112552434, CN112552433, CN112552429, and CN112552428. Although a number of metal-ligand complexes having a constrained geometry have been developed, there is still a need for further development of new complexes suitable for producing polyolefins having tailored properties, including particular molecular weight ranges, molecular weight distributions, tacticity, or like features at a given reaction temperature.

### SUMMARY

In various aspects, the present disclosure provides one or more metal-ligand complexes comprising: a transition metal atom or a lanthanide metal atom and a ligand having a structure represented by Formula 1

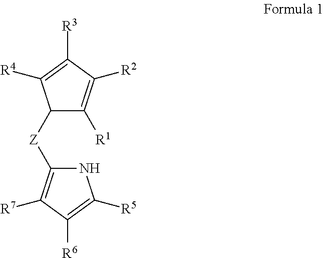

wherein: R¹ and R² are independently hydrogen or a C₁-C₁₄ hydrocarbyl group; R³ and R⁴ are independently hydrogen or a C₁-C₁₄ hydrocarbyl group, or R³ and R⁴ are joined together to form an optionally substituted 6-membered aromatic ring; R⁵ is hydrogen, C₁-C₁₀ alkyl, C₃-C₁₀ cycloalkyl, C₆-C₃₀ aryl, a heteroaryl group, or CN, provided that R⁵ is C₃-C₁₀ cycloalkyl, C₆-C₃₀ aryl, a heteroaryl group, or CN if the transition metal atom is Ti or Zr and R³ and R⁴ are joined together to form a 6-membered aromatic ring, or provided that R⁵ is C₁-C₁₀ alkyl, C₃-C₁₀ cycloalkyl, C₆-C₃₀ aryl, a heteroaryl group, or CN if the transition metal atom is Ti or Zr and R¹-R⁴ are all H; R⁶ and R⁷ are independently hydrogen or a C₁-C₁₄ hydrocarbyl group; and Z is a bridging atom.

In other various aspects, the present disclosure provides catalyst systems. The catalyst systems comprise: at least one activator, and a metal-ligand complex comprising a transition metal atom or a lanthanide metal atom and a ligand having a structure represented by Formula 1

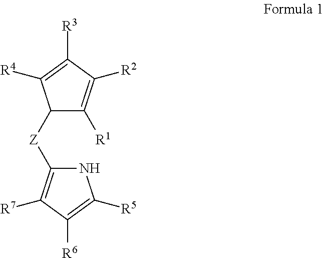

wherein: R¹ and R² are independently hydrogen or a C₁-C₁₄ hydrocarbyl group; R³ and R⁴ are independently hydrogen or a C₁-C₁₄ hydrocarbyl group, or R³ and R⁴ are joined together to form an optionally substituted 6-membered aromatic ring; R⁵ is hydrogen, C₁-C₁₀ alkyl, C₃-C₁₀ cycloalkyl, C₆-C₃₀ aryl, a heteroaryl group, or CN, provided that R⁵ is C₃-C₁₀ cycloalkyl, C₆-C₃₀ aryl, a heteroaryl group, or CN if the transition metal atom is Ti or Zr and R³ and R⁴ are joined together to form a 6-membered aromatic ring, or provided that R⁵ is C₁-C₁₀ alkyl, C₃-C₁₀ cycloalkyl, C₆-C₃₀ aryl, a heteroaryl group, or CN if the transition metal atom is Ti or Zr and R¹-R⁴ are all H; R⁶ and R⁷ are independently hydrogen or a C₁-C₁₄ hydrocarbyl group; and Z is a bridging atom.

In still other various aspects, the present disclosure provides olefin polymerization methods comprising: providing an olefinic feed, and contacting a catalyst system with the olefinic feed under polymerization reaction conditions. The catalyst system comprises: at least one activator, and a metal-ligand complex comprising a transition metal atom or a lanthanide metal atom and a ligand having a structure represented by Formula 1

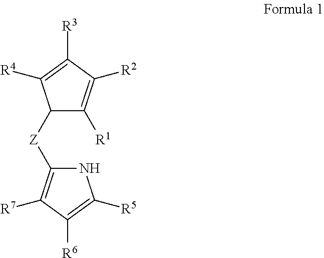

wherein: R¹ and R² are independently hydrogen or a C₁-C₁₄ hydrocarbyl group; R³ and R⁴ are independently hydrogen or a C₁-C₁₄ hydrocarbyl group, or R³ and R⁴ are joined together to form an optionally substituted 6-membered aromatic ring; R⁵ is hydrogen, C₁-C₁₀ alkyl, C₃-C₁₀ cycloalkyl, C₆-C₃₀ aryl, a heteroaryl group, or CN, provided that R⁵ is C₃-C₁₀ cycloalkyl, C₆-C₃₀ aryl, a heteroaryl group, or CN if the transition metal atom is Ti or Zr and R³ and R⁴ are joined together to form a 6-membered aromatic ring, or provided that R⁵ is C₁-C₁₀ alkyl, C₃-C₁₀ cycloalkyl, C₆-C₃₀ aryl, a heteroaryl group, or CN if the transition metal atom is Ti or Zr and R¹-R⁴ are all H; R⁶ and R⁷ are independently hydrogen or a C₁-C₁₄ hydrocarbyl group; and Z is a bridging atom.

These and other features and attributes of the disclosed complexes, systems, and/or methods of the present disclosure and their advantageous applications and/or uses will be apparent from the detailed description which follows.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, as will occur to one having ordinary skill in the art and having the benefit of this disclosure.

To assist those of ordinary skill in the relevant art in making and using the subject matter hereof, reference is made to the appended drawings, wherein:

FIG. 1 shows the X-ray crystal structure of the metal-ligand complex having Formula 3-Ti.

FIGS. 2A and 2B show alternative views of the X-ray crystal structure of the metal-ligand complex having Formula 3′-Nd.

FIGS. 3A and 3B show alternative views of the X-ray crystal structure of the metal-ligand complex having Formula 10-La.

### DETAILED DESCRIPTION

The present disclosure relates to olefin polymerization and metal-ligand complexes having a constrained geometry for use in olefin polymerization.

The present disclosure provides metal-ligand complexes having a constrained geometry, which are capable of polymerizing olefin monomers to form high molecular weight polyolefins with improved co-monomer incorporation relative to other types of catalysts.

Specific constrained geometry ligands disclosed herein include various bridged cyclopentadienyl-pyrrole ligands, which are described in further detail hereinafter. Advantageously, the constrained geometry ligands may incorporate a wide range of metals having catalytic activity, including lanthanides such as neodymium and lanthanum.

### Definitions

All numerical values within the detailed description and the claims herein are modified by “about” or “approximately” with respect to the indicated value, and take into account experimental error and variations that would be expected by a person having ordinary skill in the art. Unless otherwise indicated, room temperature is about 23° C.

As used in the present disclosure and claims, the singular forms “a,” “an,” and “the” include plural forms unless the context clearly dictates otherwise. The term “and/or” as used in a phrase such as “A and/or B” herein is intended to include “A and B,” “A or B,” “A,” and “B.”

For the purposes of the present disclosure, the new numbering scheme for groups of the Periodic Table is used. In said numbering scheme, the groups (columns) are numbered sequentially from left to right from 1 through 18, excluding the f-block elements (lanthanides and actinides). Under this scheme, the term “transition metal” refers to any atom from Groups 3-12 of the Periodic Table, inclusive of the lanthanides and actinide elements. Ti, Zr, and Hf are Group 4 transition metals, for example.

As used herein, Mn is number average molecular weight, Mw is weight average molecular weight, and Mz is z average molecular weight, wt % is weight percent, and mol % is mole percent. Molecular weight distribution (MWD), also referred to as polydispersity index (PDI), is defined to be Mw divided by Mn. Unless otherwise noted, all molecular weight units (e.g., Mw, Mn, and Mz) are in units of g/mol (g·mol⁻¹). Procedures for analyzing polymers and determining molecular weights thereof are specified below.

An “olefin,” alternatively referred to as “alkene,” is a linear, branched, or cyclic compound of carbon and hydrogen having at least one double bond. For purposes of this specification and the claims appended thereto, when a polymer or copolymer is referred to as comprising an olefin, the olefin present in such polymer or copolymer is the polymerized form of the olefin. For example, when a copolymer is said to have an “ethylene” content of 35 wt % to 55 wt %, it is understood that the mer unit in the copolymer is derived from ethylene in the polymerization reaction and said derived units are present at 35 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. Accordingly, the definition of copolymer, as used herein, includes terpolymers and the like. “Different” as used to refer to mer units indicates that the mer units differ from each other by at least one atom or are different isomerically. An “ethylene polymer” or “ethylene copolymer” is a polymer or copolymer comprising at least 50 mole % ethylene derived units, a “propylene polymer” or “propylene copolymer” is a polymer or copolymer comprising at least 50 mole % propylene derived units, and so on.

The terms “group,” “radical,” and “substituent” can be used interchangeably herein.

The term “hydrocarbon” refers to a class of compounds having hydrogen bound to carbon, and encompasses saturated hydrocarbon compounds, unsaturated hydrocarbon compounds, and mixtures of hydrocarbon compounds (saturated and/or unsaturated), including mixtures of hydrocarbon compounds having different numbers of carbon atoms. The term “Cn” refers to hydrocarbon(s) or a hydrocarbyl group having n carbon atom(s) per molecule or group, wherein n is a positive integer. Such hydrocarbon compounds may be one or more of linear, branched, cyclic, acyclic, saturated, unsaturated, aliphatic, or aromatic. As used herein, a cyclic hydrocarbon may be referred to as “carbocyclic,” which includes saturated, unsaturated, and partially unsaturated carbocyclic compounds as well as aromatic carbocyclic compounds. The term “heterocyclic” refers to a carbocyclic ring containing at least one ring heteroatom.

The terms “hydrocarbyl radical,” “hydrocarbyl group,” or “hydrocarbyl” can be used interchangeably and are defined to mean a group consisting of hydrogen and carbon atoms only and bearing at least one unfilled valence position when removed from a parent compound. Preferred hydrocarbyls are C₁-C₁₀₀ radicals that may be linear or branched. Examples of such radicals include, but are not limited to, alkyl groups such as methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and/or the like. The term “hydrocarbyl group having 1 to about 100 carbon atoms” refers to a moiety selected from a linear or branched C₁-C₁₀₀ alkyl.

The term “optionally substituted” means that a hydrocarbon or hydrocarbyl group can be unsubstituted or substituted. For example, the term “optionally substituted hydrocarbyl” refers to replacement of at least one hydrogen atom or carbon atom in a hydrocarbyl group with a heteroatom or heteroatom functional group. Unless otherwise specified as being expressly unsubstituted, any of the hydrocarbyl groups herein may be optionally substituted. The term “optionally substituted” means that a group may be unsubstituted or substituted. For example, the term “optionally substituted hydrocarbyl” refers to replacement of at least one hydrogen atom or carbon atom in a hydrocarbyl group with a heteroatom or heteroatom-containing group. Unless otherwise specified, any of the hydrocarbyl groups herein may be optionally substituted. For example, the term “substituted” means that at least one hydrogen atom has been replaced with at least a non-hydrogen group, such as a hydrocarbyl group, a heteroatom, or a heteroatom-containing group, such as halogen (such as Br, Cl, F or I) or at least one functional group such as —NR*2, —OR*, —SeR*, —TeR*, —PR*2, —AsR*₂, —SbR*₂, —SR*, —BR*₂, —SiR*, —SiR*₃, —GeR*, —GeR*₃, —SnR*, —SnR*₃, —PbR*₃, and the like, where each R* is independently a hydrocarbyl or halocarbyl radical, and two or more R* may join together to form a substituted or unsubstituted saturated, partially unsaturated or aromatic cyclic or polycyclic ring structure, or where at least one heteroatom has been inserted within a ring structure.

The terms “hydrocarbyl radical,” “hydrocarbyl,” and “hydrocarbyl group,” are used interchangeably throughout this application. Likewise, the terms “group”, “radical”, and “substituent” may be used interchangeably and are defined to mean a group consisting of hydrogen and carbon atoms only. Preferred hydrocarbyls are C₁-C₁₀₀ radicals that may be linear, branched, or cyclic, and when cyclic, aromatic or non-aromatic. Examples of such radicals include, but are not limited to, alkyl groups such as methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like, aryl groups, such as phenyl, benzyl naphthyl, and the like.

Substituted hydrocarbyl radicals are radicals in which at least one hydrogen atom of the hydrocarbyl radical has been replaced with a heteroatom, or a heteroatom-containing group, such as halogen (such as Br, Cl, F or I) or at least one functional group such as —NR*2, —OR*, —SeR*, —TeR*, —PR*₂, —AsR*₂, —SbR*₂, —SR*, —BR*₂, —SiR*, —SiR*₃, —GeR*, —GeR*₃, —SnR*, —SnR*₃, —PbR*₃, and the like, where each R* is independently a hydrocarbyl or halocarbyl radical, and two or more R* may join together to form a substituted or unsubstituted saturated, partially unsaturated or aromatic cyclic or polycyclic ring structure, or where at least one heteroatom has been inserted within a hydrocarbyl ring.

Cyclopentadiene and fused cyclopentadienes (e.g., indene, tetrahydroindene, and fluorene) may complex a metal atom through π-bonding. Substituted cyclopentadienyl, indenyl, tetrahydroindenyl or fluorenyl groups are cyclopentadienyl, indenyl, tetrahydroindenyl or fluorenyl groups where at least one hydrogen atom has been replaced with at least a non-hydrogen group, such as a hydrocarbyl group, a heteroatom, or a heteroatom-containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*, —SiR*₃, —GeR*, —GeR*₃, —SnR*, —SnR*₃, —PbR*₃, and the like, where each R* is independently a hydrocarbyl or halocarbyl radical, and two or more R* may join together to form a substituted or unsubstituted saturated, partially unsaturated or aromatic cyclic or polycyclic ring structure, or where at least one heteroatom has been inserted within a ring structure.

Halocarbyl radicals (also referred to as halocarbyls, halocarbyl groups or halocarbyl substituents) are radicals in which one or more hydrocarbyl hydrogen atoms have been substituted with at least one halogen (e.g., F, Cl, Br, I) or halogen-containing group. Substituted halocarbyl radicals are radicals in which at least one halocarbyl hydrogen or halogen atom has been substituted with at least one functional group such as NR*₂, OR*, SeR*, TeR*, PR*₂, AsR*₂, SbR*₂, SR*, BR*₂, SiR*₃, GeR*₃, SnR*₃, PbR*₃, and the like or where at least one non-carbon atom or group has been inserted within the halocarbyl radical such as —O—, —S—, —Se—, —Te—, —N(R*)—, =N—, —P(R*)—, =P—, —As(R*)—, ═As—, —Sb(R*)—, —Sb—, —B(R*)—, =B—, —Si(R*)₂—, —Ge(R*)₂—, —Sn(R*)₂—, —Pb(R*)₂— and the like, where R* is independently a hydrocarbyl or halocarbyl radical provided that at least one halogen atom remains on the original halocarbyl radical. Additionally, two or more R* may join together to form a substituted or unsubstituted saturated, partially unsaturated or aromatic cyclic or polycyclic ring structure.

Hydrocarbylsilyl groups, also referred to as silylcarbyl groups, are radicals in which one or more hydrocarbyl hydrogen atoms have been substituted with at least one SiR*₃ containing group or where at least one —Si(R*)₂₋ has been inserted within the hydrocarbyl radical where R* is independently a hydrocarbyl or halocarbyl radical, and two or more R* may join together to form a substituted or unsubstituted saturated, partially unsaturated or aromatic cyclic or polycyclic ring structure. Silylcarbyl radicals can be bonded via a silicon atom or a carbon atom.

Substituted silylcarbyl radicals are silylcarbyl radicals in which at least one hydrogen atom has been substituted with at least one functional group such as NR*₂, OR*, SeR*, TeR*, PR*₂, AsR*₂, SbR*₂, SR*, BR*₂, GeR*₃, SnR*₃, PbR₃ and the like or where at least one non-hydrocarbon atom or group has been inserted within the silylcarbyl radical, such as —O—, —S—, —Se—, —Te—, —N(R*)—, =N—, —P(R*)—, =P—, —As(R*)—, ═As—, —Sb(R*)—, =Sb—, —B(R*)—, =B—, —Ge(R*)₂—, —Sn(R*)₂—, —Pb(R*)₂— and the like, where R* is independently a hydrocarbyl or halocarbyl radical, and two or more R* may join together to form a substituted or unsubstituted saturated, partially unsaturated or aromatic cyclic or polycyclic ring structure.

Germylcarbyl radicals (also referred to as germylcarbyls, germylcarbyl groups or germylcarbyl substituents) are radicals in which one or more hydrocarbyl hydrogen atoms have been substituted with at least one GeR*₃ containing group or where at least one —Ge(R*)₂₋ has been inserted within the hydrocarbyl radical where R* is independently a hydrocarbyl or halocarbyl radical, and two or more R* may join together to form a substituted or unsubstituted saturated, partially unsaturated or aromatic cyclic or polycyclic ring structure. Germylcarbyl radicals can be bonded via a germanium atom or a carbon atom.

Substituted germylcarbyl radicals are germylcarbyl radicals in which at least one hydrogen atom has been substituted with at least one functional group such as NR*₂, OR*, SeR*, TeR*, PR*2, AsR*₂, SbR*₂, SR*, BR*₂, SiR*₃, SnR*₃, PbR₃ and the like or where at least one non-hydrocarbon atom or group has been inserted within the germylcarbyl radical, such as —O—, —S—, —Se—, —Te—, —N(R*)—, ═N—, —P(R*)—, —P—, —As(R*)—, ═As—, —Sb(R*)—, ═Sb—, —B(R*)—, ═B—, —Si(R*)₂—, —Sn(R*)₂—, —Pb(R*)₂— and the like, where R* is independently a hydrocarbyl or halocarbyl radical, and two or more R* may join together to form a substituted or unsubstituted saturated, partially unsaturated or aromatic cyclic or polycyclic ring structure.

The terms “alkyl radical,” and “alkyl” are used interchangeably throughout this application. For purposes of this application, “alkyl radicals” are defined to be C₁-C₁₀₀ alkyls that may be linear, branched, or cyclic. Examples of such radicals can include methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like. Substituted alkyl radicals are radicals in which at least one hydrogen atom of the alkyl radical has been substituted with at least a non-hydrogen group, such as a hydrocarbyl group, a heteroatom, or a heteroatom-containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*, —SiR*₃, —GeR*, —GeR*₃, —SnR*, —SnR*₃, —PbR*₃, and the like, where each R* is independently a hydrocarbyl or halocarbyl radical, and two or more R* may join together to form a substituted or unsubstituted saturated, partially unsaturated or aromatic cyclic or polycyclic ring structure, or where at least one heteroatom has been inserted within a hydrocarbyl ring.

The term “branched alkyl” means that the alkyl group contains a tertiary or quaternary carbon (a tertiary carbon is a carbon atom bound to three other carbon atoms; a quaternary carbon is a carbon atom bound to four other carbon atoms). For example, 3,5,5-trimethylhexylphenyl is an alkyl group (hexyl) having three methyl branches (hence, one tertiary and one quaternary carbon) and thus is a branched alkyl bound to a phenyl group.

The term “alkenyl” means a straight-chain, branched-chain, or cyclic hydrocarbon radical having one or more carbon-carbon double bonds. These alkenyl radicals may be substituted. Examples of suitable alkenyl radicals can include ethenyl, propenyl, allyl, 1,4-butadienyl cyclopropenyl, cyclobutenyl, cyclopentenyl, cyclohexenyl, cyclooctenyl and the like.

The term “arylalkenyl” means an aryl group where a hydrogen has been replaced with an alkenyl or substituted alkenyl group. For example, styryl indenyl is an indene substituted with an arylalkenyl group (a styrene group).

The term “alkoxy”, “alkoxyl”, or “alkoxide” mean an alkyl group bound to an oxygen atom, such as an alkyl ether or aryl ether group/radical and can include those where the alkyl group is a C₁ to C₁₀ hydrocarbyl. The alkyl group may be straight chain, branched, or cyclic. The alkyl group may be saturated or unsaturated. Examples of suitable alkoxy groups and radicals can include methoxy, ethoxy, n-propoxy, iso-propoxy, n-butoxy, iso-butoxy, sec-butoxy, tert-butoxy, and the like.

The term “aryloxy” or “aryloxide” means an aryl group bound to an oxygen atom, such as an aryl ether group/radical wherein the term aryl is as defined herein. Examples of suitable aryloxy radicals can include phenoxyl, and the like.

The term “aryl” or “aryl group” means a carbon-containing aromatic ring such as phenyl or fused phenyl. Likewise, heteroaryl means an aryl group where a ring carbon atom (or two or three ring carbon atoms) has been replaced with a heteroatom, such as N, O, or S. As used herein, the term “aromatic” also refers to pseudoaromatic heterocycles which are heterocyclic substituents that have similar properties and structures (nearly planar) to aromatic heterocyclic ligands, but are not by definition aromatic.

Heterocyclic means a cyclic group where a ring carbon atom (or two or three ring carbon atoms) has been replaced with a heteroatom, such as N, O, or S. A heterocyclic ring is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylaminophenyl is a heteroatom-substituted ring.

Substituted heterocyclic means a heterocyclic group where at least one hydrogen atom of the heterocyclic radical has been substituted with at least a non-hydrogen group, such as a hydrocarbyl group, a heteroatom, or a heteroatom-containing group, such as halogen (such as Br, Cl, F or I) or at least one functional group such as —NR*2, —OR*, —SeR*, —TeR*, —PR*2, —AsR*₂, —SbR*₂, —SR*, —BR*₂, —SiR*, —SiR*₃, —GeR*, —GeR*₃, —SnR*, —SnR*₃, —PbR*₃, and the like, where each R* is independently a hydrocarbyl or halocarbyl radical.

A substituted aryl is an aryl group where at least one hydrogen atom of the aryl radical has been substituted with at least a non-hydrogen group, such as a hydrocarbyl group, a heteroatom, or a heteroatom-containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*, —SiR*₃, —GeR*, —GeR*₃, —SnR*, —SnR*₃, —PbR*₃, and the like, where each R* is independently a hydrocarbyl or halocarbyl radical, and two or more R* may join together to form a substituted or unsubstituted saturated, partially unsaturated or aromatic cyclic or polycyclic ring structure, or where at least one heteroatom has been inserted within a hydrocarbyl ring. For example, 3,5-dimethylphenyl is a substituted aryl group.

The term “substituted phenyl,” or “substituted phenyl group” means a phenyl group having one or more hydrogen groups replaced by a hydrocarbyl, substituted hydrocarbyl, heteroatom or heteroatom-containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*, —SiR*₃, —GeR*, —GeR*₃, —SnR*, —SnR*₃, —PbR*₃, and the like, where each R* is independently a hydrocarbyl, halogen, or halocarbyl radical. Preferably the “substituted phenyl” group is represented by the formula:

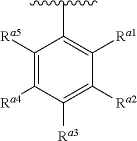

where each of R^{a1}, R^{a2}, R^{a3}, R^{a4}, and R^{a5} is independently selected from hydrogen, C₁-C₄₀ hydrocarbyl or C₁-C₄₀ substituted hydrocarbyl, a heteroatom, such as halogen, or a heteroatom-containing group (provided that at least one of R^{a1}, R^{a2}, R^{a3}, R^{a4}, and R^{a5} is not H), or two or more of R^{a1}, R^{a2}, R^{a3}, R^{a4}, and R^{a5} are joined together to form a C₄-C₆₂ cyclic or polycyclic ring structure, or a combination thereof. Fused bicyclic and polycyclic aromatic rings are included within the definition of substituted phenyl groups.

The term “substituted naphthyl,” means a naphthyl group having 1 or more hydrogen groups replaced by a hydrocarbyl, substituted hydrocarbyl, heteroatom or heteroatom-containing group.

A “fluorophenyl” or “fluorophenyl group” is a phenyl group substituted with one, two, three, four or five fluorine atoms.

The term “substituted fluorenyl” means a fluorenyl group having 1 or more hydrogen groups replaced by a hydrocarbyl, substituted hydrocarbyl, heteroatom or heteroatom-containing group.

The term “arylalkyl” means an aryl group where a hydrogen has been replaced with an alkyl or substituted alkyl group. For example, 3,5′-di-tert-butylphenyl indenyl is an indene substituted with an arylalkyl group. When an arylalkyl group is a substituent on another group, it is bound to that group via the aryl. For example, the aryl portion may be bound to E.

The term “alkylaryl” means an alkyl group where a hydrogen has been replaced with an aryl or substituted aryl group. For example, phenethyl indenyl is an indene substituted with an ethyl group bound to a benzene group. When an alkylaryl group is a substituent on another group, it is bound to that group via the alkyl.

Reference to an alkyl, alkenyl, alkoxide, or aryl group without specifying a particular isomer (e.g., butyl) expressly discloses all isomers (e.g., n-butyl, iso-butyl, sec-butyl, and tert-butyl), unless otherwise indicated.

The term “ring atom” means an atom that is part of a cyclic ring structure. Accordingly, a benzyl group has 6 ring atoms and tetrahydrofuran has 5 ring atoms.

As used herein, and unless otherwise specified, the term “Cn” means hydrocarbon(s) having n carbon atom(s) per molecule, wherein n is a positive integer.

The term “hydrocarbon” means a class of compounds containing hydrogen bound to carbon, and encompasses (i) saturated hydrocarbon compounds, (ii) unsaturated hydrocarbon compounds, and (iii) mixtures of hydrocarbon compounds (saturated and/or unsaturated), including mixtures of hydrocarbon compounds having different values of n. Likewise, a “Cₘ-C_{y}” group or compound refers to a group or compound comprising carbon atoms at a total number thereof in the range from m to y. Thus, a C₁-C₅₀ alkyl group refers to an alkyl group comprising carbon atoms at a total number thereof in the range from 1 to 50.

A “catalyst system” is a combination of at least one catalyst compound, at least one activator, an optional co-activator, and an optional support material. When “catalyst system” is used to describe such a pair before activation, it means the unactivated catalyst complex (precatalyst) together with an activator and, optionally, a co-activator. When it is used to describe such a pair after activation, it means the activated complex and the activator or other charge-balancing moiety. The transition metal compound may be neutral as in a precatalyst, or a charged species with a counter ion as in an activated catalyst system. For the purposes of this disclosure and the claims thereto, when catalyst systems are described as comprising neutral stable forms of the components, it is well understood by one of ordinary skill in the art, that the ionic form of the component is the form that reacts with the monomers to produce polymers.

“Complex” or “metal-ligand complex” as used herein, may also be referred to as catalyst precursor, precatalyst, catalyst, catalyst compound, transition metal compound, or transition metal complex. These words may be used interchangeably.

In the description herein, a catalyst may be described as a catalyst precursor, a pre-catalyst compound, a catalyst compound or a transition metal compound, and these terms are used interchangeably. A polymerization catalyst system is a catalyst system that can polymerize monomers into polymer. An “anionic ligand” is a negatively charged ligand which donates one or more pairs of electrons to a metal atom, such as a transition metal atom or a lanthanide metal atom. A “neutral donor ligand” is a neutrally charged ligand which donates one or more pairs of electrons to a metal atom, such as a transition metal atom or a lanthanide metal atom.

The term “metallocene” describes an organometallic compound with at least one π-bound cyclopentadienyl moiety or substituted cyclopentadienyl moiety (such as substituted or unsubstituted cyclopentadienyl (Cp) and/or indenyl (Ind)) and more frequently two (or three) π-bound cyclopentadienyl moieties or substituted cyclopentadienyl moieties (such as substituted or unsubstituted Cp and/or Ind).

The term “post-metallocene” describes transition metal complexes that do not feature any π-coordinated cyclopentadienyl anion donors (or the like) and are useful to the polymerization of olefins when combined with common activators.

The following abbreviations may be used herein: Me is methyl, Et is ethyl, Pr is propyl, cPR is cyclopropyl, nPr is n-propyl, iPr is isopropyl, Bu is butyl, nBu is normal butyl, iBu is isobutyl, sBu is sec-butyl, tBu is tert-butyl, Oct is octyl, Ph is phenyl, MAO is methylalumoxane, dme is 1,2-dimethoxyethane, p-tBu is para-tertiary butyl, TMS is trimethylsilyl, TIBAL is triisobutylaluminum, TNOAL is tri(n-octyl)aluminum, p-Me is para-methyl, Bz and Bn are benzyl (i.e., CH₂Ph), THF (also referred to as thf) is tetrahydrofuran, RT is room temperature (and is 23° C. unless otherwise indicated), tol is toluene, EtOAc is ethyl acetate, Cbz is Carbazole, and Cy is cyclohexyl.

“Catalyst productivity” is a measure of the mass of polymer produced using a known quantity of polymerization catalyst. Typically, “catalyst productivity” is expressed in units of (g of polymer)/(g of catalyst) or (g of polymer)/(mmols of catalyst) or the like. If units are not specified then the “catalyst productivity” is in units of (g of polymer)/(grams of catalyst). For calculating catalyst productivity only the weight of the transition metal component of the catalyst is used (i.e., the activator and/or co-catalyst is omitted). “Catalyst activity” is a measure of the mass of polymer produced using a known quantity of polymerization catalyst per unit time for batch and semi-batch polymerizations. For calculating catalyst productivity only the weight of the transition metal component of the catalyst is used (i.e. the activator and/or co-catalyst is omitted). Typically, “catalyst activity” is expressed in units of (g of polymer)/(mmol of catalyst)/hour or (kg of polymer)/(mmols of catalyst)/hour or the like. If units are not specified then the “catalyst activity” is in units of (g of polymer)/(mmol of catalyst)/hour.

“Conversion” is the percentage of a monomer that is converted to polymer product in a polymerization, and is reported as % and is calculated based on the polymer yield, the polymer composition, and the amount of monomer fed into the reactor.

### Ligands and Metal-Ligand Complexes

Metal-ligand complexes of the present disclosure may comprise a transition metal atom or a lanthanide metal atom and a ligand having a structure represented by Formula 1 below.

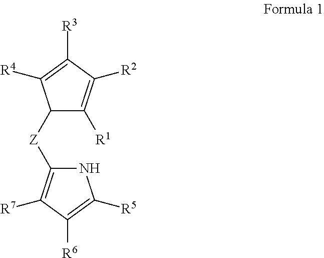

In Formula 1, R¹ and R² are independently hydrogen or a C₁-C₄₀ optionally substituted hydrocarbyl, halocarbyl, silylcarbyl, aminocarbyl, germylcarbyl, oxyhydrocarbyl, halide, or siloxyl group, more preferably independently hydrogen or a C₁-C₄₀ optionally substituted hydrocarbyl group, or still more preferably independently hydrogen or a C₁-C₁₄ hydrocarbyl group; R³ and R⁴ are independently hydrogen or a C₁-C₄₀ optionally substituted hydrocarbyl, halocarbyl, silylcarbyl, aminocarbyl, germylcarbyl, oxyhydrocarbyl, halide, or siloxyl group, more preferably independently hydrogen or a C₁-C₄₀ optionally substituted hydrocarbyl group, or still more preferably independently hydrogen or a C₁-C₁₄ hydrocarbyl group, or R³ and R⁴ are joined together to form an optionally substituted 6-membered aromatic ring; R⁵ is hydrogen, C₁-C₁₀ alkyl, C₃-C₁₀ cycloalkyl, C₆-C₃₀ aryl, a heteroaryl group, or CN, provided that R⁵ is C₃-C₁₀ cycloalkyl, C₆-C₃₀ aryl, a heteroaryl group, or CN if the transition metal atom is Ti or Zr and R³ and R⁴ are joined together to form a 6-membered aromatic ring, or provided that R⁵ is C₁-C₁₀ alkyl, C₃-C₁₀ cycloalkyl, C₆-C₃₀ aryl, a heteroaryl group, or CN if the transition metal atom is Ti or Zr and R¹-R⁴ are all H; R⁶ and R⁷ are independently hydrogen or a C₁-C₄₀ optionally substituted hydrocarbyl, halocarbyl, silylcarbyl, aminocarbyl, germylcarbyl, oxyhydrocarbyl, halide, or siloxyl group, more preferably independently hydrogen or a C₁-C₄₀ optionally substituted hydrocarbyl group, or still more preferably independently hydrogen or a C₁-C₁₄ hydrocarbyl group, or still more preferably hydrogen; and Z is a bridging atom, preferably a carbon atom. The ligand having a structure represented by Formula 1 may be bonded in at least a bidentate fashion to the transition metal atom or the lanthanide metal atom in the metal-ligand complexes disclosed herein.

In some embodiments, the metal-ligand complex may have a structure represented by Formula 1A below

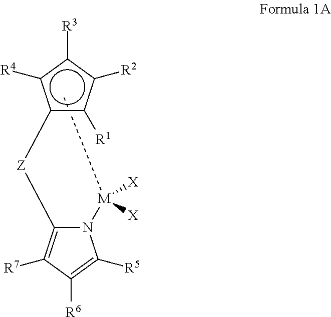

In Formula 1A, M is the transition metal atom or the lanthanide metal atom, and X is independently a leaving group, or two Xs are joined and bound to M to form a metallocycle ring, a chelating ligand, a diene ligand, or an alkylidene. The other variables are defined as further specified herein.

In Formula 1A, X is independently a leaving group, where each X group can be same or different. Examples of suitable leaving groups X include, but are not limited to, a C₁ to C₂₀ hydrocarbyl group (e.g., an alkyl group or an aryl group), a hydride, an amide, an alkoxide, a sulfide, a phosphide, a halide, an amine, a phosphine, an ether, or any combination thereof. Leaving groups X may be in a deprotonated or protonated (neutral) form. Preferably, one or more of the leaving groups X is a halide, an aryl group, a C₁ to C₂₀ alkyl group, an amide, or a combination thereof. More preferably one or more of the X groups is an amide (e.g., dimethylamido, diethylamido, or dimethylsilylamido). In the context of a leaving group, the term “amide” refers to an amine compound that has been deprotonated to leave a negative charge on nitrogen. Thus, dimethylamine may be deprotonated to form a dimethylamido ligand. Optionally, two of the X groups may be joined and bound to M to form a metallocycle ring, a chelating ligand, a diene ligand, or an alkylidene.

Optionally, the metal-ligand complexes may comprise a second ligand complexed to the transition metal atom or the lanthanide metal atom. For example, the metal-ligand complexes may comprise a solvent or a Lewis base complexed to the transition metal atom or the lanthanide metal atom M as a second ligand. Example solvents and Lewis bases may include representative members of X groups, discussed above. More specific examples may include, but are not limited to, tertiary phosphines (PR₃), phosphine oxides (OPR₃), tertiary amines (NR₃), pyridine, DMAP, THF and other ether solvents, and the like.

In more specific embodiments, the transition metal atom or the lanthanide metal atom may include a Group 4 metal (e.g., titanium (Ti), zirconium (Zr), or hafnium (Ha); chromium (Cr); and/or a lanthanide metal (e.g., gadolinium (Gd), neodymium (Nd) or lanthanum (La)). In still more specific examples, the transition metal atom or the lanthanide metal atom may be hafnium, chromium, neodymium, or lanthanum.

In Formulas 1 and 1A, Z is a bridging group. Examples of suitable bridging groups Z include, but are not limited to: R′₂C, R′₂Si, R′₂Ge, R′₂CCR′₂, R′₂CCR′₂CR′₂, R′₂CCR′₂CR′₂CR′₂, R′C═CR′, R′C═CR′CR′₂, R′₂CCR′═CR′CR′₂, R′C═CR′CR′═CR′, R′C═CR′CR′₂CR′₂, R′₂CSIR′₂, R′₂SiSiR′₂, R²CSIR′₂CR′₂, R′₂SiCR′₂SiR′₂, R′C—CR′SiR′₂, R′₂CGeR′₂, R′₂GeGeR′₂, R′₂CGeR′₂CR′₂, R′₂GeCR′₂GeR′₂, R′₂SiGeR′₂, R′C═CR′GeR′₂, R′B, R′₂C—BR′, R′₂C—BR′—CR′₂, R′₂C—O—CR′₂, R′₂CR′₂C—O—CR′₂CR′₂, R′₂C—O—CR′₂CR′₂, R′₂C—O—CR′═CR′, R′₂C—S—CR′₂, R′₂CR′₂C—S—CR′₂CR′₂, R′₂C—S—CR′₂CR′₂, R′₂C—S—CR′═CR′, R′₂C—Se—CR′₂, R′₂CR′₂C—Se—CR′₂CR′₂, R′₂C—Se—CR₂CR′₂, R′₂C—Se—CR′—CR′, R′₂C—N═CR′, R′₂C—NR′—CR′₂, R′₂C—NR′—CR′₂CR′₂, R′₂C—NR′—CR′—CR′, R′₂CR′₂C—NR′—CR′₂CR′₂, R′₂C═P═CR′, and R′₂C—PR′—CR′₂, where R′ is hydrogen or a C₁-C₂₀ hydrocarbyl, substituted hydrocarbyl, halocarbyl, substituted halocarbyl, silylcarbyl or germylcarbyl substituent. Optionally, two or more adjacent R′ can be joined to form a substituted or unsubstituted, saturated, partially unsaturated or aromatic, cyclic or polycyclic substituent. Particularly suitable examples of bridging groups Z include, R′₂Si (more preferably, R′ is methyl) and CR′₂ (more preferably, R′ is H). That is, in a particular example, Z may be CH₂.

In Formulas 1 and 1A, R¹ and R² and/or R⁶ and R⁷ may be independently hydrogen or a C₁-C₄₀ optionally substituted hydrocarbyl, halocarbyl, silylcarbyl, aminocarbyl, germylcarbyl, oxyhydrocarbyl, halide, or siloxyl group. Preferably, R¹ and R² and/or R⁶ and R⁷ are independently hydrogen or a C₁-C₄₀ optionally substituted hydrocarbyl. More preferably, R¹ and R² and/or R⁶ and R⁷ are independently hydrogen or a C₁-C₁₄ optionally substituted hydrocarbyl. Still more preferably, R¹ and R² and/or R⁶ and R⁷ are independently hydrogen, C₁-C₁₀ alkyl, or C₆-C₁₀ aryl. Example R¹ and/or R² and/or R⁶ and R⁷ groups may include, but are not limited to hydrogen, optionally substituted C₁-C₁₀ alkyl groups (e.g., methyl group, ethyl group, propyl group, butyl group, pentyl group, hexyl group), and optionally substituted phenyl. In a particular example, R⁶ and R⁷ may both be hydrogen.

In Formulas 1 and 1A, R³ and R⁴ may be independently hydrogen or a C₁-C₄₀ optionally substituted hydrocarbyl, halocarbyl, silylcarbyl, aminocarbyl, germylcarbyl, oxyhydrocarbyl, halide, or siloxyl group. Preferably, R³ and R⁴ are independently hydrogen or a C₁-C₄₀ optionally substituted hydrocarbyl. More preferably, R³ and R⁴ are independently hydrogen or a C₁-C₁₄ optionally substituted hydrocarbyl. Optionally, R³ and R⁴ may be joined together to form an optionally substituted carbocyclic or heterocyclic ring. For instance, R³ and R⁴ may form an optionally substituted cycloaliphatic, aromatic or heteroaromatic ring. In one example, R³ and R⁴ may form an optionally substituted 6-membered aromatic ring, in which R⁵ may be C₁-C₁₀ alkyl or C₆-C₃₀ aryl. Further, R³ and R⁴ may form a fused ring that bears one or more additional fused rings. Example R³ and/or R⁴ groups may include, but are not limited to, hydrogen, optionally substituted C₁-C₁₀ alkyl groups (e.g., methyl group, ethyl group, propyl group, butyl group, pentyl group, hexyl group), and optionally substituted phenyl.

In Formulas 1 and 1A, R⁵ is hydrogen, C₁-C₃₀ alkyl, C₃-C₃₀ cycloalkyl, C₆-C₃₀ aryl, a heteroaryl, or an amide. Preferably, R⁵ is hydrogen, C₁-C₁₀ alkyl, C₃-C₁₀ cycloalkyl, C₆-C₃₀ aryl, a heteroaryl group, or CN. In various embodiments, R⁵ is C₃-C₁₀ cycloalkyl, C₆-C₃₀ aryl, a heteroaryl group, or CN if the transition metal atom is Ti or Zr, and R³ and R⁴ are joined together to form a 6-membered aromatic ring. In other various embodiments, R⁵ is C₁-C₁₀ alkyl, C₃-C₁₀ cycloalkyl, C₆-C₃₀ aryl, a heteroaryl group, or CN if the transition metal atom is Ti or Zr and R¹-R⁴ are all H. In more specific examples of any of the foregoing, R⁵ may be t-butyl or optionally substituted phenyl.

The ligand having a structure represented by Formula 1 may be alternately represented by Formula 2 below,

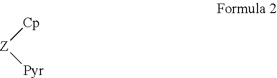

wherein Cp represents an optionally substituted cyclopentadienyl portion of the ligand, Pyr represents an optionally substituted pyrrolidinyl portion of the ligand, and Z is defined as above. Optionally substituted cyclopentadienyl portions include, but are not limited to, fused cyclopentadienyl rings, such as indenyl rings. The optionally substituted cyclopentadienyl portion of the optionally substituted pyrrolidinyl portion of the ligand may be substituted with one or more substituents specified in more detail above.

Specific examples of structures that may be present in the cyclopentadienyl (Cp) portion of Formula 2 include, but are not limited to, those having structures represented by the following formulas (the wavy line indicates bonding to Z):

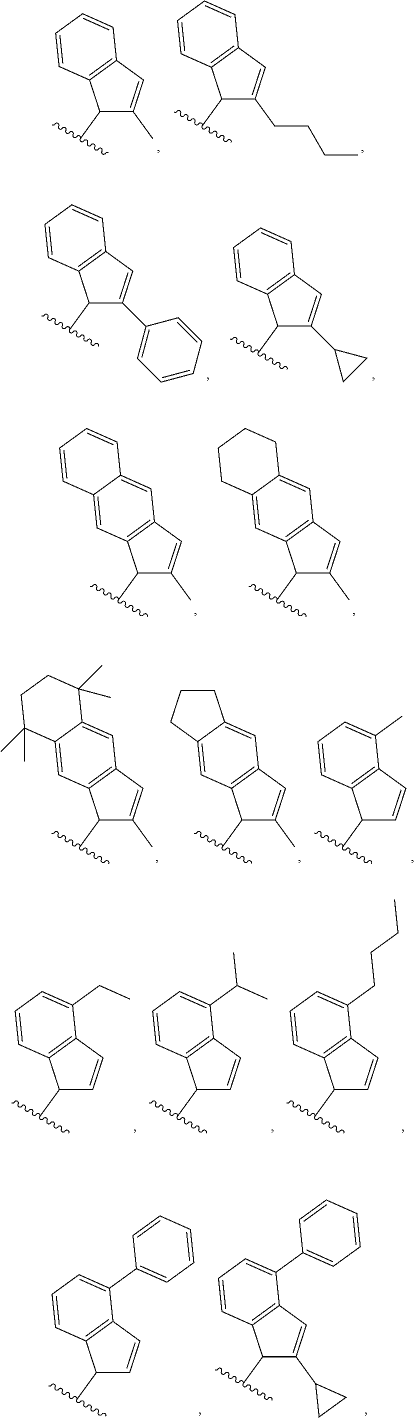

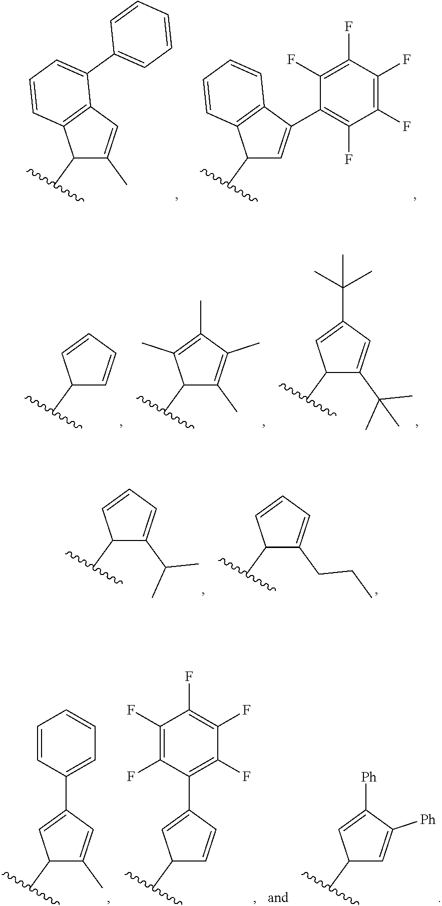

Specific examples of structures that may be present in the pyrrolidinyl (Pyr) portion of Formula 2 include, but are not limited to, those having structures represented by the following formulas (the wavy lines indicate bonding to Z or a metal-ligand bond from the pyrrolidinyl nitrogen atom):

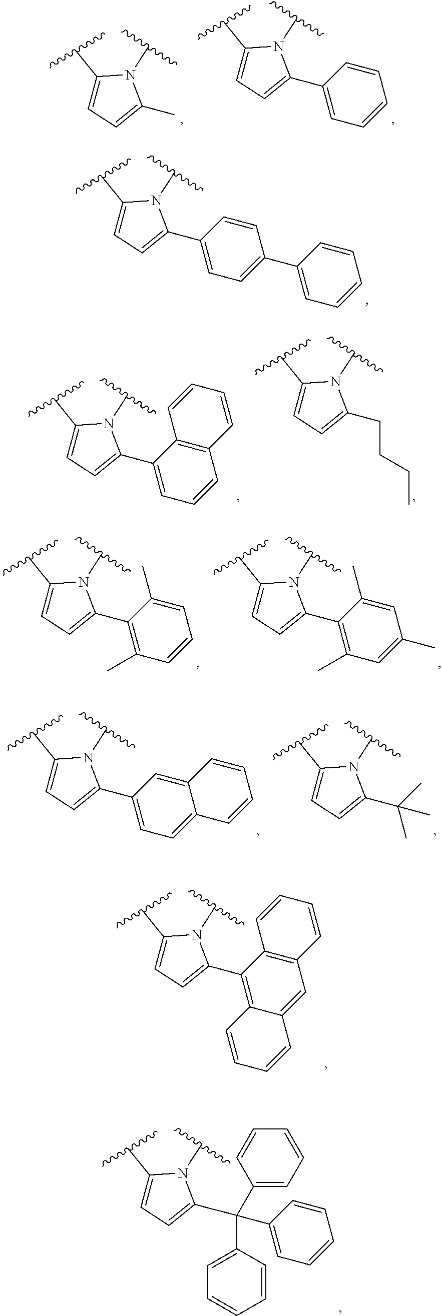

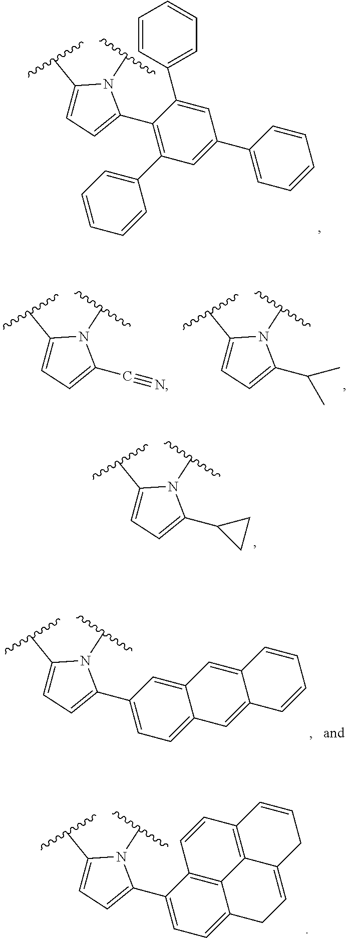

Specific examples of ligands defined by Formula 2 may include, but are not limited to, those defined by Formulas 3-9 below.

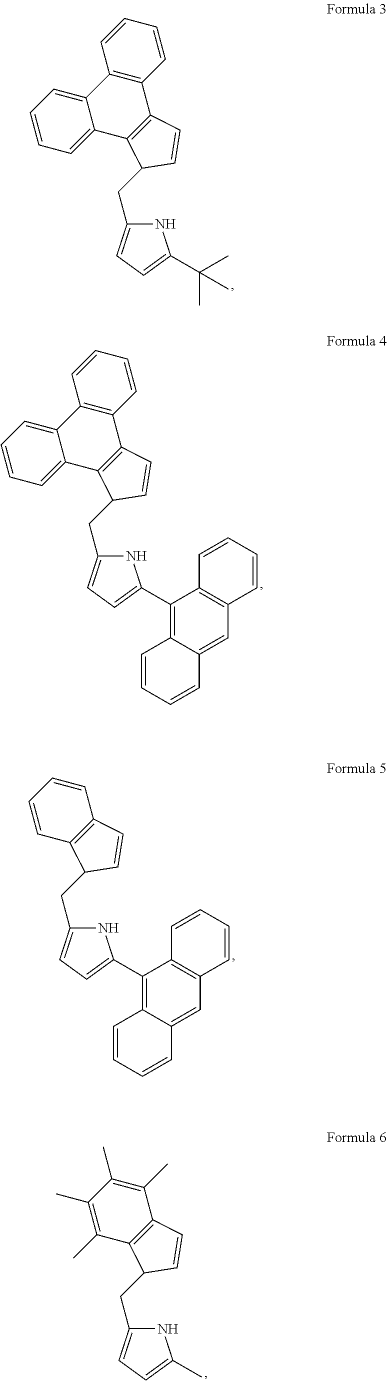

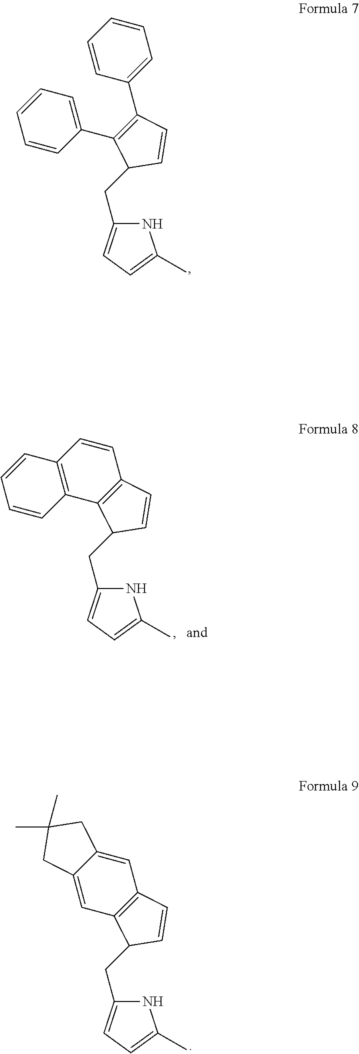

Specific examples of metal-ligand complexes defined by Formula 1A may include, but are not limited to, those having structures represented by the following formulas. Optionally, a solvent or Lewis base may be ligated within the coordination sphere of M.

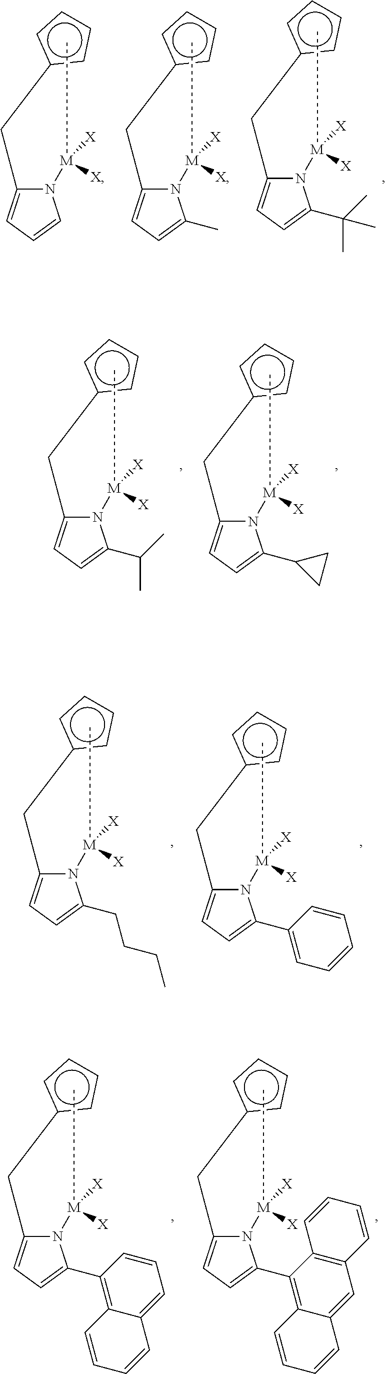

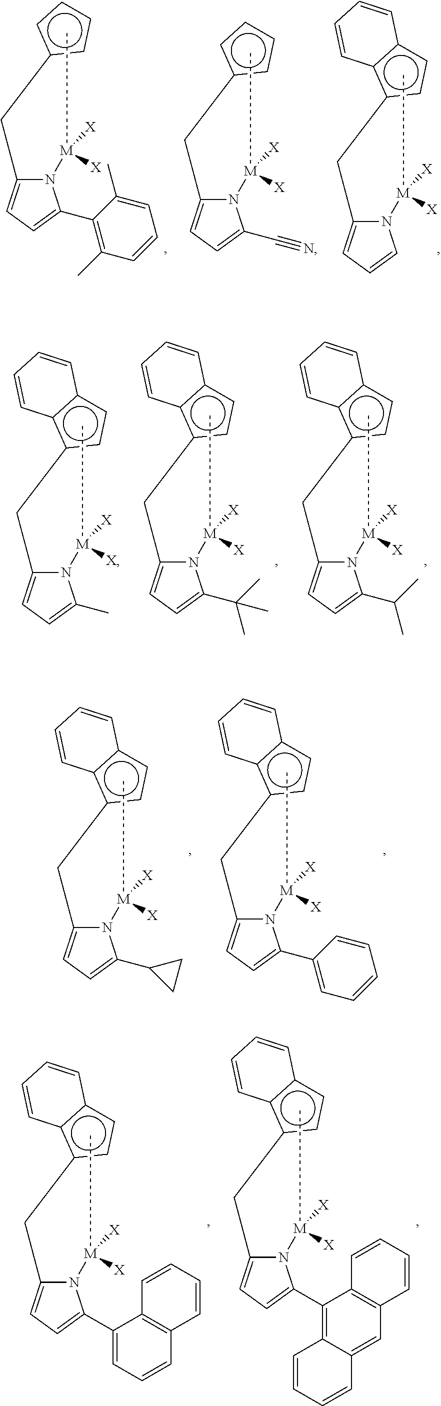

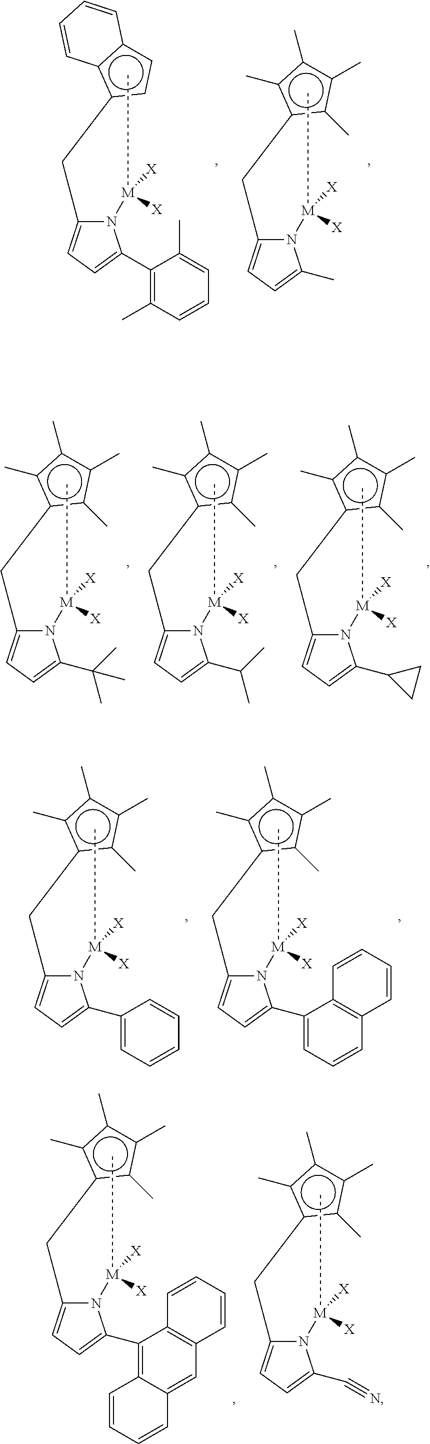

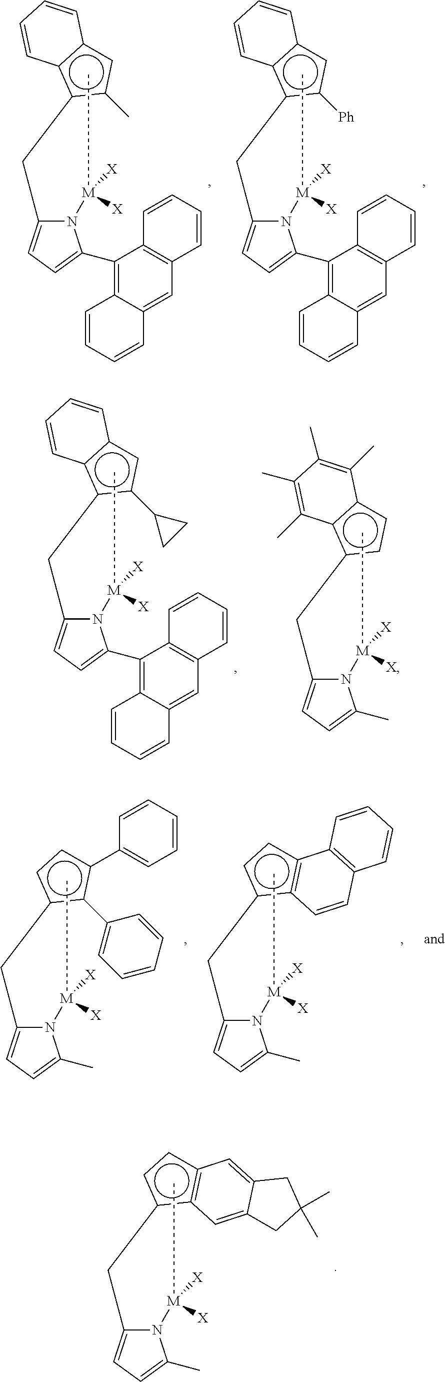

In more specific examples, the present disclosure provides metal-ligand complexes having structures represented by Formulas 3-M through 9-M below, wherein M represents the metal in Formula 1A being complexed by the ligand, specifically the ligands represented by Formulas 3-9:

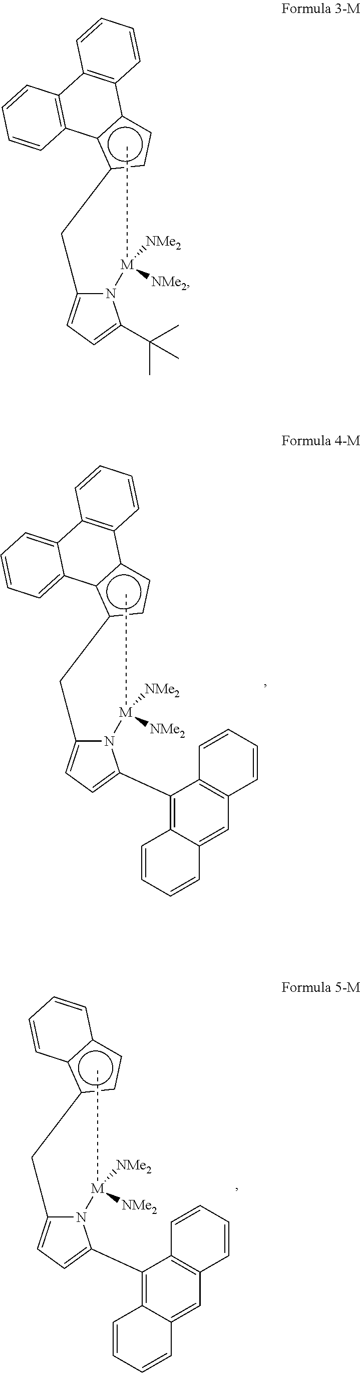

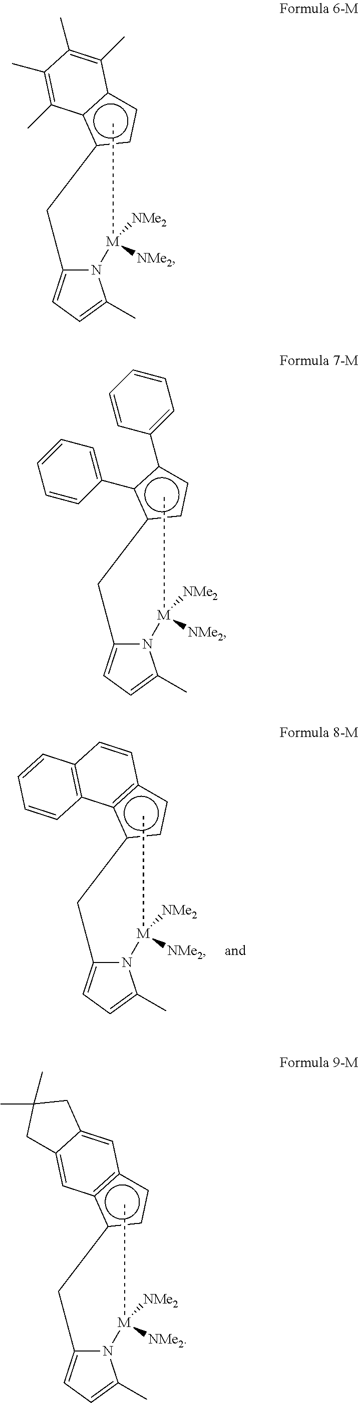

In any of the foregoing specific examples, M may be Ti, Zr, or Hf, for instance. For purposes of discussion below, such metal-ligand complexes may be referred to as Formula 3-Ti, Formula 3-Zr, Formula 3-Hf, Formula 4-Ti, Formula 4-Zr, Formula 4-Hf, Formula 5-Ti, Formula 5-Zr, Formula 5-Hf, Formula 6-Ti, Formula 6-Zr, Formula 6-Hf, Formula 7-Ti, Formula 7-Zr, Formula 7-Hf, Formula 8-Ti, Formula 8-Zr, Formula 8-Hf, Formula 9-Ti, Formula 9-Zr, and Formula 9-Hf.

In other more specific examples, the present disclosure provides metal-ligand complexes having structures represented by Formulas 3′-M through 9′-M below, wherein M represents the metal in Formula 1A being complexed by the ligand, specifically the ligands of Formulas 3-9, and THF.

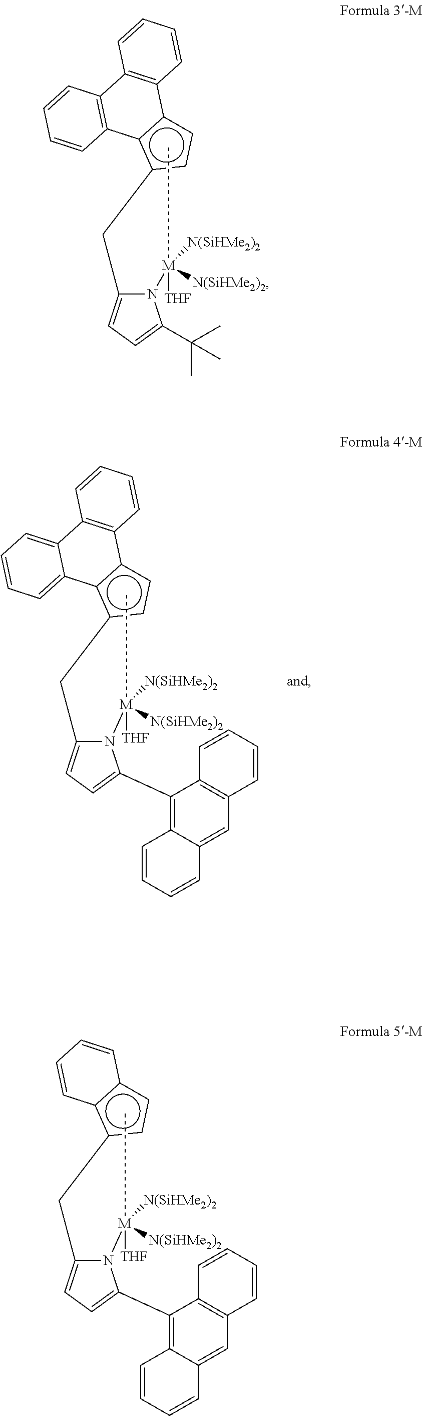

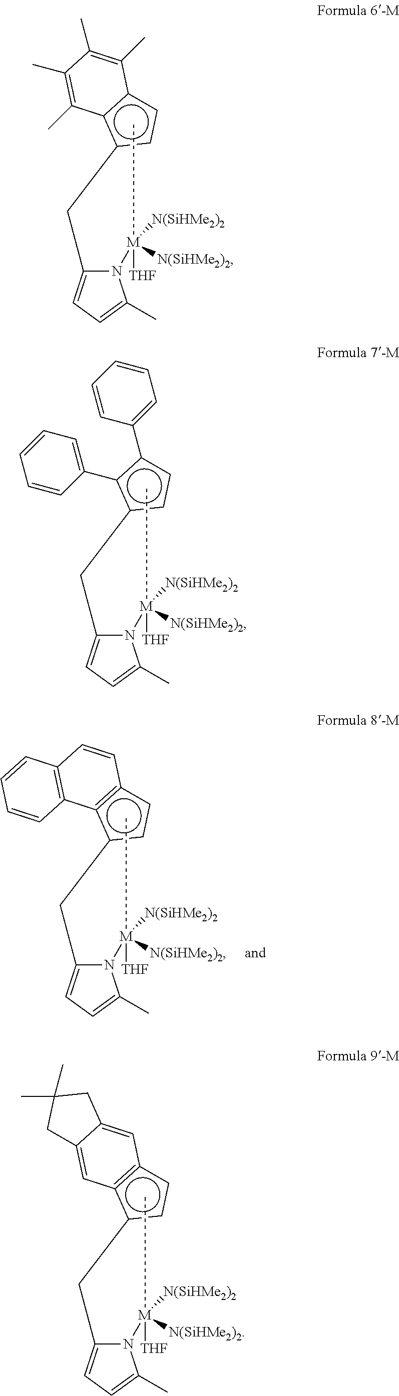

In any of the foregoing specific examples, M may be La or Nd, for instance. For purposes of discussion below, such metal-ligand complexes may be referred to as Formula 3′-Nd, Formula 3′-La, Formula 4′-Nd, Formula 4′-La, Formula 5′-Nd, Formula 5′-La, Formula 6′-Nd, Formula 6′-La, Formula 7′-Nd, Formula 7′-La, Formula 8′-Nd, Formula 8′-La, Formula 9′-Nd, and Formula 9′-La.

In still additional specific examples, the ligands may form dimeric metal-ligand complexes. Example dimeric metal-ligand complexes may have structures represented by Formulas 10-12 below.

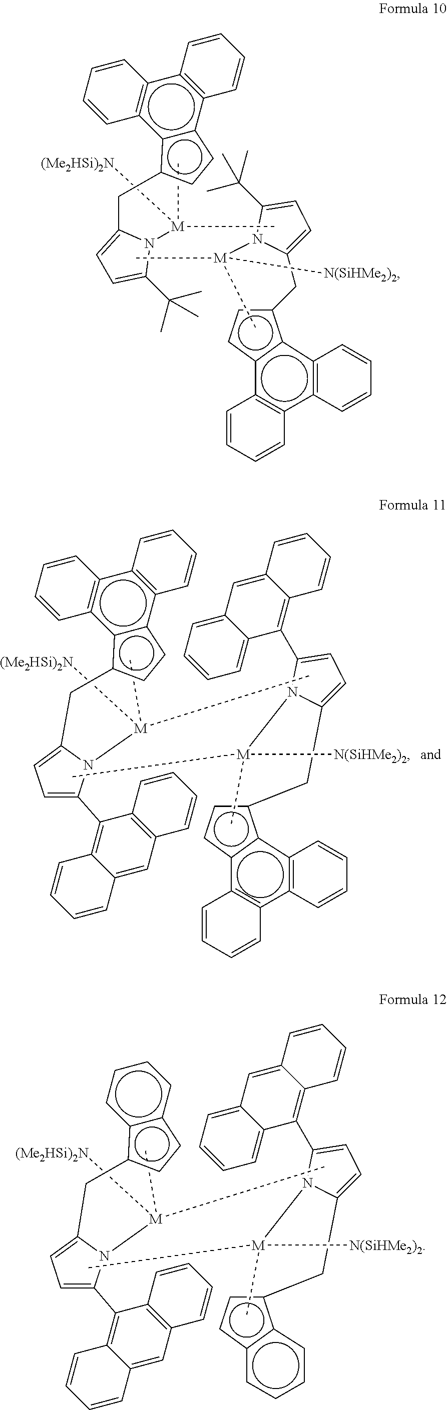

### In any of Formulas 10-12, M may be La.

Scheme 1 below shows a general synthetic route through which the ligands and metal-ligand complexes of the present disclosure can be prepared using a multi-step synthesis. Scheme 1 illustrates an example scalable synthetic route for ligands having 2-aryl substituted pyrroles, which may be accessed via commercially available N-Boc-2-pyrrole boronic acid (BOC=2-t-butoxycarbonyl). In Scheme 1, reaction step (i) is a cross coupling reaction, where “Ar” is an aryl group and “X” is a leaving group (e.g., a halide). For example, the reaction step (i) can be a Suzuki-Miyaura crossing coupling reaction using palladium or nickel catalysts. Reaction step (ii) is an ester deprotection reaction to form the 2-aryl substituted pyrrole. Reaction step (iii) is formylation reaction, where the 2-aryl substituted pyrrole is functionalized with a formyl group. In reaction step (iv), the 2-aryl substituted pyrrole is functionalized with indenyl to form the bridged structure of the ligand. Reaction step (v) is a reduction of the alkylidene group to form a CH₂ bridge. Reaction step (vi) forms the metal-ligand complex from the ligand. As shown in Scheme 1, the metal compound can comprise a metal M and one or more amido leaving groups X (e.g., NMe₂).

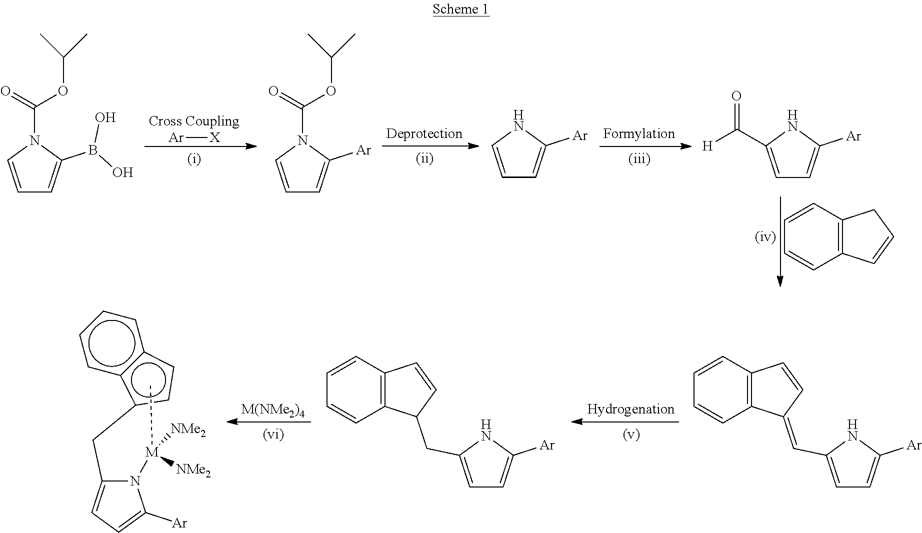

Scheme 2 below shows another general synthetic route through which the ligands and metal-ligand complexes of the present disclosure can be prepared using a multi-step synthesis. Scheme 2 illustrates an example scalable synthetic route for ligands having 2-alkyl substituted pyrroles. In reaction step (i), pyrrole can be functionalized with a precursor to a formyl group and subsequently alkylated with an alkyl group in step (ii). In reaction step (iii), the 2-alkyl substituted pyrrole is functionalized with indenyl to form the bridged structure of the ligand. Reaction step (iv) is a reduction of the alkylidene group to form a CH₂ bridge. Reaction step (v) forms the metal-ligand complex from the ligand. As shown in Scheme 2, the metal compound can comprise a metal M and one or more amido leaving groups X (e.g., NMe₂).

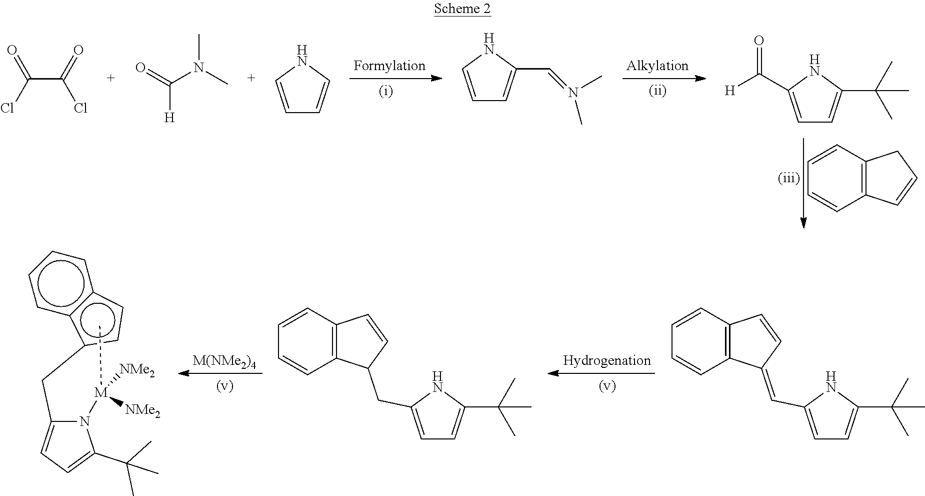

Catalyst systems of the present disclosure may comprise at least one activator, and one or more of the metal-ligand complexes described above. Polymerization processes of the present disclosure may comprise contacting an olefinic feed with the catalyst systems under suitable polymerization reaction conditions. Without being bound by any theory or mechanism, the at least one activator can react with the metal-ligand complex to promote loss of a ligand to open a coordination site at which polymerization of an olefin may occur. In particular, the at least one activator is believed to remove at least one of the leaving groups to form a catalytically active species.

In some embodiments, catalyst systems described herein may comprise one metal-ligand complex, rather than using two or more metal-ligand complexes that are different. For purposes of this disclosure, one metal-ligand complex is considered different from another if the two complexes differ by at least one atom.

In other embodiments, two or more different metal-ligand complexes may be present in the various catalyst systems described herein. In some embodiments, two or more different metal-ligand complexes may be present in a reaction zone where a polymerization process described herein occurs. When two or more metal-ligand complexes are used in one reactor as a mixed catalyst system, the two or more metal-ligand complexes are preferably chosen such that they are compatible. A simple screening method such as by ¹H or ¹³C NMR, known to those of ordinary skill in the art, can be used to determine whether two or more metal-ligand complexes are compatible. It is preferable to use the same activator for the metal-ligand complexes; however, two different activators, such as a non-coordinating anion activator and an alumoxane, can be used in combination. If one or more metal-ligand complexes contain a leaving group X ligand which is not a hydride, hydrocarbyl, or substituted hydrocarbyl, then the alumoxane may be contacted with the transition metal compounds prior to addition of the non-coordinating anion activator.

Multiple metal-ligand complexes may be used in any ratio in a catalyst system or polymerization process. Preferred molar ratios of (A) metal-ligand complex to (B) metal-ligand complex may fall within the range of (A:B) 1:1000 to 1000:1, alternatively 1:100 to 500:1, alternatively 1:10 to 200:1, alternatively 1:1 to 100:1, and alternatively 1:1 to 75:1, and alternatively 5:1 to 50:1. The particular ratio chosen will depend on the exact pre-catalysts chosen, the method of activation, and the end product desired. In particular embodiments, when using the two pre-catalysts, where both are activated with the same activator, useful mole percent values, based upon the molecular weight of the pre-catalysts, are 10% to 99.9% A to 0.1% to 90% B, alternatively 25% to 99% A to 0.5% to 50% B, alternatively 50% to 99% A to 1 to 25% B, and alternatively 75% to 99% A to 1% to 10% B.

The terms “cocatalyst” and “activator” are used herein interchangeably. The catalyst systems described herein typically comprise a metal-ligand complex as described above and an activator such as alumoxane or a non-coordinating anion and can be formed by combining the catalyst components described herein with activators in any manner known from the literature including combining them with supports, such as silica. The catalyst systems can also be added to or generated in solution polymerization or bulk polymerization (in the monomer). Catalyst systems of the present disclosure can have one or more activators and one, two or more metal-ligand complexes. Activators are defined to be any compound which can activate any one of the catalyst compounds described above by converting the neutral metal compound to a catalytically active metal compound cation. Non-limiting activators, for example, include alumoxanes, aluminum alkyls, ionizing activators, which may be neutral or ionic, and conventional-type cocatalysts. Preferred activators typically include alumoxane compounds, modified alumoxane compounds, and ionizing anion precursor compounds that abstract a reactive, o-bound, metal ligand making the metal compound cationic and providing a charge-balancing non-coordinating or weakly coordinating anion, e.g. a non-coordinating anion.

Alumoxane activators are utilized as activators in the catalyst systems described herein. Alumoxanes are generally oligomeric compounds containing —Al(R)—O— sub-units, where R is an alkyl group. Examples of alumoxanes include methylalumoxane (MAO), modified methylalumoxane (MMAO), ethylalumoxane and isobutylalumoxane. Alkylalumoxanes and modified alkylalumoxanes are suitable as catalyst activators, particularly when the abstractable ligand is an alkyl, halide, alkoxide or amide. Mixtures of different alumoxanes and modified alumoxanes can also be used. It may be preferable to use a visually clear methylalumoxane. A cloudy or gelled alumoxane can be filtered to produce a clear solution or clear alumoxane can be decanted from the cloudy solution. A useful alumoxane is a modified methyl alumoxane (MMAO) cocatalyst type 3A (commercially available from Akzo Chemicals, Inc. under the trade name Modified Methylalumoxane type 3A, covered under patent number U.S. Pat. No. 5,041,584). Another useful alumoxane is solid polymethylaluminoxane as described in U.S. Pat. Nos. 9,340,630; 8,404,880; and 8,975,209.

When the activator is an alumoxane (modified or unmodified), some embodiments select the maximum amount of activator typically at up to a 5000-fold molar excess Al/M over the catalyst compound (per metal catalytic site). The minimum activator-to-catalyst-compound is a 1:1 molar ratio. Alternate preferred ranges include from 1:1 to 500:1, alternately from 1:1 to 200:1, alternately from 1:1 to 100:1, or alternately from 1:1 to 50:1.

In an alternate embodiment, little or no alumoxane is used in the polymerization processes described herein. Preferably, alumoxane is present at zero mole %, alternately the alumoxane is present at a molar ratio of aluminum to catalyst compound transition metal less than 500:1, preferably less than 300:1, preferably less than 100:1, preferably less than 1:1.

Other suitable activators for the catalysts can include compounds containing a non-coordinating anion, especially borane and borate compounds. Particularly useful borane and borate compounds containing a non-coordinating anion or similar entity include, for example, B(C₆F₅)₃, [PhNMe₂H]⁺[B(C₆F₅)₄], [Ph₃C]⁺[B(C₆F₅)₄]⁻, and [PhNMe₂H]⁺[B(C₁₀F₇)₄]⁻.

The term “non-coordinating anion” (NCA) means an anion which either does not coordinate to a cation or which is only weakly coordinated to a cation thereby remaining sufficiently labile to be displaced by a neutral Lewis base. The term NCA is defined to include multicomponent NCA-containing activators, such as N,N-dimethylanilinium tetrakis(pentafluorophenyl)borate and N,N-dimethylanilinium tetrakis(heptafluoronaphthyl)borate, that contain an acidic cationic group and the non-coordinating anion. The term NCA is also defined to include neutral Lewis acids, such as tris(pentafluorophenyl)boron, that can react with a catalyst to form an activated species by abstraction of an anionic group. Typically, NCAs coordinate weakly enough that a neutral Lewis base, such as an olefinically or acetylenically unsaturated monomer can displace it from the catalyst center. Any metal or metalloid that can form a compatible, weakly coordinating complex may be used or contained in the non-coordinating anion. Suitable metals include, but are not limited to, aluminum, gold, and platinum. Suitable metalloids include, but are not limited to, boron, aluminum, phosphorus, and silicon. The term non-coordinating anion includes neutral activators, ionic activators, and Lewis acid activators.

“Compatible” non-coordinating anions are those which are not degraded to neutrality when the initially formed complex decomposes. Further, the anion will not transfer an anionic substituent or fragment to the cation so as to cause it to form a neutral transition metal compound and a neutral by-product from the anion. Non-coordinating anions useful in accordance with this invention are those that are compatible, stabilize the transition metal cation in the sense of balancing its ionic charge at +1, and yet retain sufficient lability to permit displacement during polymerization. Ionizing activators useful herein typically comprise an NCA, particularly a compatible NCA.

It is within the scope of this invention to use an ionizing activator, neutral or ionic. It is also within the scope of this invention to use neutral or ionic activators alone or in combination with alumoxane or modified alumoxane activators. For descriptions of useful activators please see U.S. Pat. Nos. 8,658,556 and 6,211,105.

It is within the scope of the present disclosure to use an ionizing, neutral, or ionic activator, such as tri(n-butyl) ammonium tetrakis(pentafluorophenyl)borate, a tris perfluorophenylboron metalloid precursor or a trisperfluoronaphthylboron metalloid precursor, polyhalogenated heteroborane anions (WO1998/043983), boric acid (U.S. Pat. No. 5,942,459), or any combination thereof. It is also within the scope of the present disclosure to use neutral or ionic activators alone or in combination with alumoxane activators.

The catalyst systems of the present disclosure may include at least one non-coordinating anion (NCA) activator. In preferred embodiments, boron-containing NCA activators represented by Formula 13 below may be used,

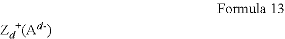

where Z is (L-H) or a reducible Lewis acid; L is a neutral Lewis base; His hydrogen; (L-H) is a Bronsted acid; A^{d-} is a boron-containing non-coordinating anion having the charge d⁻; and d is 1, 2, or 3.

The cation component Z_{d}⁺ may include Bronsted acids such as protons or protonated Lewis bases or reducible Lewis acids capable of protonating or abstracting a moiety from the metal-ligand complexes to afford a cationic metal-ligand complex.

The cation component Z_{d}⁺ may also be a moiety such as silver, tropylium, carboniums, ferroceniums and mixtures thereof, preferably carboniums and ferroceniums. Suitable reducible Lewis acids include any triaryl carbonium (where the aryl can be substituted or unsubstituted, such as those represented by the formula: (Ar₃C⁺), where Ar is aryl or aryl substituted with a heteroatom, a C₁ to C₄₀ hydrocarbyl, or a substituted C₁ to C₄₀ hydrocarbyl). Preferably, the reducible Lewis acids in Formula 5 above defined as “Z” include those represented by the formula: (Ph₃C), where Ph is a substituted or unsubstituted phenyl, preferably substituted with C₁ to C₄₀ hydrocarbyls or substituted a C₁ to C₄₀ hydrocarbyls, preferably C₁ to C₂₀ alkyls or aromatics or substituted C₁ to C₂₀ alkyls or aromatics, and preferably Z_{d}⁺ is triphenylcarbonium.

When Z_{d}⁺ is the activating cation (L-H)_{d}⁺, it is preferably a Bronsted acid, capable of donating a proton to the transition metal catalytic precursor resulting in a transition metal cation, including ammoniums, oxoniums, phosphoniums, silyliums, and mixtures thereof, preferably ammoniums of methylamine, aniline, dimethylamine, diethylamine, N-methylaniline, diphenylamine, trimethylamine, triethylamine, N,N-dimethylaniline, methyldiphenylamine, pyridine, p-bromo-N,N-dimethylaniline, p-nitro-N,N-dimethylaniline, phosphoniums from triethylphosphine, triphenylphosphine, and diphenylphosphine, oxoniums from ethers such as dimethyl ether diethyl ether, tetrahydrofuran and dioxane, sulfoniums from thioethers, such as diethyl thioethers, tetrahydrothiophene, and mixtures thereof.

The anion component A^{d-} includes those having the formula [M^{k+}G]^{d-} wherein k is 1, 2, or 3; g is 1, 2, 3, 4, 5, or 6 (preferably 1, 2, 3, or 4); g−k=d; M is an element selected from Group 13 of the Periodic Table of the Elements, preferably boron or aluminum, and G is independently a hydride, bridged or unbridged dialkylamido, halide, alkoxide, aryloxide, hydrocarbyl, substituted hydrocarbyl, halocarbyl, substituted halocarbyl, and halo-substituted hydrocarbyl radicals, said G having up to 20 carbon atoms with the proviso that in not more than 1 occurrence is G a halide. Preferably, each G is a fluorinated hydrocarbyl group having 1 to 20 carbon atoms, more preferably, each G is a fluorinated aryl group, and most preferably, each G is a pentafluoroaryl group. Examples of suitable A^{d-} also include diboron compounds as disclosed in U.S. Pat. No. 5,447,895, which is fully incorporated herein by reference with respect to the diboron compounds disclosed therein.

Illustrative but not limiting examples of boron compounds which may be used as an activator are the compounds described as (and particularly those specifically listed as) activators in U.S. Pat. No. 8,658,556, which is incorporated by reference herein with respect to the boron compounds disclosed therein.

Most preferably, the activator Z_{d}⁺ (A^{d-}) is one or more of N,N-dimethylanilinium tetra (perfluorophenyl)borate, N,N-dimethylanilinium tetrakis(perfluoronaphthyl)borate, N,N-dimethylanilinium tetrakis(perfluorobiphenyl)borate, N,N-dimethylanilinium tetrakis(3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate, or triphenylcarbenium tetra (perfluorophenyl)borate. In any embodiment, the non-coordinating anion may be selected from N,N-dimethylanilinium tetrakis(perfluoronaphthyl)borate, N,N-dimethylanilinium tetrakis(perfluorobiphenyl)borate, N,N-dimethylanilinium tetrakis(perfluorophenyl)borate, N,N-dimethylanilinium tetrakis(3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate, triphenylcarbenium tetrakis(perfluorophenyl)borate, [Me₃NH⁺][B(C₆F₅)⁴⁻], 1-(4-(tris(pentafluorophenyl)borate)-2,3,5,6-tetrafluorophenyl) pyrrolidinium; [Me₃NH⁺][B(C₆F₅)⁴⁻], 1-(4-(tris(pentafluorophenyl)borate)-2,3,5,6-tetrafluorophenyl) pyrrolidinium, sodium tetrakis(pentafluorophenyl)borate, potassium tetrakis(pentafluorophenyl)borate, and 4-(tris(pentafluorophenyl)borate)-2,3,5,6-tetrafluoropyridinium. Preferably, the non-coordinating anion may be N,N-dimethylanilinium tetrakis(perfluoronaphthyl)borate.

Bulky activators are also useful herein as NCAs. “Bulky activator” as used herein refers to anionic activators represented by Formulas 14 or 15 below.

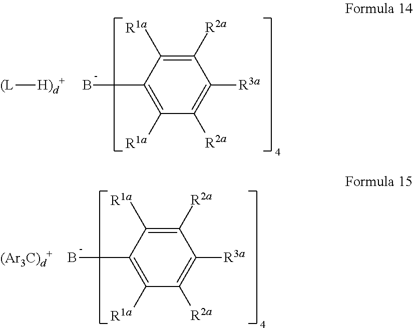

In Formulas 14 and 15, each R^{1a} is, independently, a halide, preferably a fluoride; Ar is substituted or unsubstituted aryl group (preferably a substituted or unsubstituted phenyl), preferably substituted with C₁ to C₄₀ hydrocarbyls, preferably C₁ to C₂₀ alkyls or aromatics; each R^{2a} is, independently, a halide, a C, to C₂₀ substituted aromatic hydrocarbyl group or a siloxy group of the formula-O—Si—R^{a}, where R^{a} is a C₁ to C₂₀ hydrocarbyl or hydrocarbylsilyl group (preferably R^{2a} is a fluoride or a perfluorinated phenyl group); each R^{3a} is a halide, C₆ to C₂₀ substituted aromatic hydrocarbyl group or a siloxy group of the formula —O—Si—R^{a}, where R^{a} is a C₁ to C₂₀ hydrocarbyl or hydrocarbylsilyl group (preferably R^{3a} is a fluoride or a C₆ perfluorinated aromatic hydrocarbyl group); wherein R^{2a} and R^{3a} can form one or more saturated or unsaturated, substituted or unsubstituted rings (preferably R^{2a} and R^{3a} form a perfluorinated phenyl ring); and L is a neutral Lewis base; (L-H) is a Bronsted acid; d is 1, 2, or 3; wherein the anion has a molecular weight of greater than 1020 g/mol; wherein at least three of the substituents on the B atom each have a molecular volume of greater than 250 cubic Å, greater than 300 cubic Å, or greater than 500 cubic Å, as specified below.

Preferably, (Ar₃C)_{d}⁺ is (Ph₃C)_{d}⁺, where Ph is a substituted or unsubstituted phenyl, preferably substituted with C₁ to C₄₀ hydrocarbyls or substituted C₁ to C₄₀ hydrocarbyls, preferably C₁ to C₂₀ alkyls or aromatics or substituted C₁ to C₂₀ alkyls or aromatics.

“Molecular volume” is used herein as an approximation of spatial steric bulk of an activator molecule in solution. Comparison of substituents with differing molecular volumes allows the substituent with the smaller molecular volume to be considered “less bulky” in comparison to the substituent with the larger molecular volume. Conversely, a substituent with a larger molecular volume may be considered “more bulky” than a substituent with a smaller molecular volume. Molecular volume may be calculated as reported in “A Simple “Back of the Envelope” Method for Estimating the Densities and Molecular Volumes of Liquids and Solids,” Journal of Chemical Education, vol. 71 (11), November 1994, pp. 962-964. Molecular volume (MV), in units of cubic Å, is calculated using the formula: MV=8.3V_{S}, where V_{S} is the scaled volume. V_{S} is the sum of the relative volumes of the constituent atoms, and is calculated from the molecular formula of the substituent using Table 1 below of relative volumes. For fused rings, the V_{S} is decreased by 7.5% per fused ring. The Calculated Total MV of the anion is the sum of the MV per substituent, for example, the MV of perfluorophenyl is 183 Å3, and the Calculated Total MV for tetrakis(perfluorophenyl)borate is four times 183 Å³, or 732 Å³.

TABLE 1

| Element | Relative Volume |
|---|---|
| H | 1 |
| 1^{st} short period, Li to F | 2 |
| 2^{nd} short period, Na to Cl | 4 |
| 1^{st} long period, K to Br | 5 |
| 2^{nd} long period, Rb to I | 7.5 |
| 3^{rd} long period, Cs to Bi | 9 |

For a list of particularly useful bulky activators, U.S. Pat. No. 8,658,556, which is incorporated by reference herein with respect to its disclosure of bulk activators, may be consulted.

In any embodiment, a NCA activator may be an activator as described in U.S. Pat. No. 6,211,105. The NCA activator-to-catalyst ratio may be from about a 1:1 molar ratio to about a 1000:1 molar ratio, which includes, from about 0.1:1 to about 100:1 from about 0.5:1 to about 200:1, from about 1:1 to about 500:1, or from about 1:1 to about 1000:1. A particularly useful range is from about 0.5:1 to about 10:1, preferably about 1:1 to about 5:1.

It is also within the scope of this disclosure that the metal-ligand complexes may be activated with combinations of alumoxanes and NCAs (see for example, U.S. Pat. Nos. 5,153,157 and 5,453,410; EP 0 573 120 B1, and International Patent Application Publications WO1994/007928 and WO1995/014044, which discuss the use of an alumoxane in combination with an ionizing activator).

In addition to activator compounds, scavengers or co-activators can be used. Aluminum alkyl or organoaluminum compounds which may be utilized as scavengers or co-activators include, for example: trimethylaluminum, triethylaluminum, triisobutylaluminum, tri-n-hexylaluminum, tri-n-octylaluminum, ethylaluminum dichloride, diethylaluminum chloride, and diethyl zinc.

Chain transfer agents can also be used in the compositions and/or processes described herein. Useful chain transfer agents are typically alkylalumoxanes, a compound represented by the formula AlR₃, ZnR₂ (where each R is, independently, a C₁-C₈ aliphatic radical, preferably methyl, ethyl, propyl, butyl, penyl, hexyl octyl or an isomer thereof) or a combination thereof, such as diethyl zinc, methylalumoxane, trimethylaluminum, triisobutylaluminum, trioctylaluminum, or a combination thereof.

In any embodiment, a catalyst system suitable for use in the methods and systems disclosed herein may be disposed on a solid support. The solid support may allow a catalytic reaction, such as polymerization of an olefinic feed, to be conducted under heterogeneous conditions. In more specific embodiments, the solid support may be silica. Other suitable solid supports may include, but are not limited to, alumina, magnesium chloride, talc, inorganic oxides, or chlorides including one or more metals from Groups 2, 3, 4, 5, 13, or 14 of the Periodic Table, and polymers such as polystyrene, or functionalized and/or cross-linked polymers. Other inorganic oxides that may suitably function as solid supports include, for example, titania, zirconia, boron oxide, zinc oxide, magnesia, or any combination thereof. Combinations of inorganic oxides may be suitably used as solid supports as well. Illustrative combinations of suitable inorganic oxides include, but are not limited to, silica-alumina, silica-titania, silica-zirconia, silica-boron oxide, and the like.

In any embodiment, an alumoxane or other suitable activator may be disposed on silica or another suitable solid support before being combined with the metal-ligand complexes disclosed herein. The metal-ligand complexes disclosed herein can be disposed upon silica or another suitable support before being combined with an alumoxane or other suitable activator. Upon combining the activator and the solid support with the metal-ligand complexes, the resulting catalyst system may become disposed upon the solid support. Catalyst systems having different catalytic properties can be obtained depending upon whether the metal-ligand complexes or the activator are supported on the solid support first.

In any embodiment, an alumoxane, such as MAO, may be mixed in an inert solvent such as toluene and then be slurried with a solid support, such as silica. Alumoxane deposition upon the solid support may occur at a temperature from about 60° C. to 120° C., or about 80° C. to 120° C., or about 100° C. to 120° C. Deposition occurring below 60° C., including room temperature deposition, may also be effective.

In various embodiments, the catalyst system can comprise an inert support material. Preferably the supported material is a porous support material, for example: talc, and inorganic oxides. Other support materials include zeolites, clays, organoclays, or any other organic or inorganic support material and the like, or mixtures thereof.

Preferably, the support material is an inorganic oxide in a finely divided form. Suitable inorganic oxide materials for use in catalyst systems herein include Groups 2, 4, 13, and 14 metal oxides, such as silica, alumina, and mixtures thereof. Other inorganic oxides that may be employed either alone or in combination with the silica, or alumina are magnesia, titania, zirconia, and the like. Other suitable support materials, however, can be employed, for example, finely divided functionalized polyolefins, such as finely divided polyethylene. Particularly useful supports include magnesia, titania, zirconia, montmorillonite, phyllosilicate, zeolites, talc, clays, and the like. Also, combinations of these support materials may be used, for example, silica-chromium, silica-alumina, silica-titania, and the like. Preferred support materials include Al₂O₃, ZrO₂, SiO₂, and combinations thereof, more preferably SiO₂, Al₂O₃, or SiO₂/Al₂O₃.

In any embodiment, solid supports suitable for use in the disclosure herein can have a surface area ranging from about 10 to about 700 m²/g, pore volume in the range of from about 0.1 to about 4.0 cc/g and average particle size in the range of from about 5 to about 500 μm. More preferably, the surface area of the support material is in the range of from about 50 to about 500 m²/g, pore volume of from about 0.5 to about 3.5 cc/g and average particle size of from about 10 to about 200 μm. Most preferably the surface area of the support material is in the range is from about 100 to about 400 m²/g, pore volume from about 0.8 to about 3.0 cc/g and average particle size is from about 5 to about 100 μm. The average pore size of the support material useful in the invention is in the range of from 10 to 1000 Å, preferably 50 to about 500 Å, and most preferably 75 to about 350 Å. In some embodiments, the support material is a high surface area, amorphous silica (surface area=300 m²/gm; pore volume of 1.65 cm³/gm). Preferred silicas are marketed under the tradenames of DAVISON™ 952 or DAVISON™ 955 by the Davison Chemical Division of W.R. Grace and Company. In other embodiments DAVISON™ 948 is used.

The support material may be free of absorbed water. Drying of the support material can be effected by heating or calcining at about 100° C. to about 1000° C., preferably at least about 600° C. When the support material is silica, it is heated to at least 200° C., preferably about 200° C. to about 850° C., and most preferably at about 600° C.; and for a time of about 1 minute to about 100 hours, from about 12 hours to about 72 hours, or from about 24 hours to about 60 hours. The calcined support material may have at least some reactive hydroxyl (OH) groups to produce supported catalyst systems of this invention. The calcined support material is then contacted with at least one polymerization catalyst comprising at least one catalyst compound and an activator.

The support material, having reactive surface groups, typically hydroxyl groups, is slurried in a non-polar solvent and the resulting slurry is contacted with a solution of a catalyst compound and an activator. In some embodiments, the slurry of the support material is first contacted with the activator for a period of time in the range of from about 0.5 hours to about 24 hours, from about 2 hours to about 16 hours, or from about 4 hours to about 8 hours. The solution of the catalyst compound is then contacted with the isolated support/activator. In some embodiments, the supported catalyst system is generated in situ. In alternate embodiments, the slurry of the support material is first contacted with the catalyst compound for a period of time in the range of from about 0.5 hours to about 24 hours, from about 2 hours to about 16 hours, or from about 4 hours to about 8 hours. The slurry of the supported catalyst compound is then contacted with the activator solution.

The mixture of the catalyst, activator and support is heated at about 0° C. to about 70° C., preferably at about 23° C. to about 60° C., preferably at room temperature. Contact times typically range from about 0.5 hours to about 24 hours, from about 2 hours to about 16 hours, or from about 4 hours to about 8 hours.

Suitable non-polar solvents are materials in which all of the reactants used herein, i.e., the activator, and the catalyst compound, are at least partially soluble and which are liquid at reaction temperatures. Preferred non-polar solvents are alkanes, such as isopentane, hexane, n-heptane, octane, nonane, and decane, although a variety of other materials including cycloalkanes, such as cyclohexane, aromatics, such as benzene, toluene, and ethylbenzene, may also be employed.

Various embodiments described herein further relate to polymerization processes where monomer (such as ethylene or propylene), and optionally one or more co-monomer, are contacted with a catalyst system comprising an activator and at least one metal-ligand complexes, as described above. The metal-ligand complexes and activator can be combined in any order, and are combined typically prior to contacting with the monomer. Suitable polymerization reaction conditions for conducting the polymerization reactions are provided below.

Monomers useful herein include substituted or unsubstituted C₂ to C₄₀ alpha olefins, preferably C₂ to C₂₀ alpha olefins, preferably C₂ to C₁₂ alpha olefins, preferably ethylene, propylene, butene, pentene, hexene, heptene, octene, nonene, decene, undecene, dodecene and isomers thereof. In a preferred embodiment, the monomer comprises propylene and one or more optional co-monomers comprising one or more ethylene or C₄ to C₄₀ olefins, preferably C₄ to C₂₀ olefins, or preferably C₆ to C₁₂ olefins. The C₄ to C₄₀ olefin monomers may be linear, branched, or cyclic. The C₄ to C₄₀ cyclic olefins can be strained or unstrained, monocyclic or polycyclic, and can optionally include heteroatoms and/or one or more functional groups. In another preferred embodiment, the monomer comprises ethylene and optional co-monomers comprising one or more C₃ to C₄₀ olefins, preferably C₄ to C₂₀ olefins, or preferably C₆ to C₁₂ olefins. The C₃ to C₄₀ olefin monomers can be linear, branched, or cyclic. The C₃ to C₄₀ cyclic olefins may be strained or unstrained, monocyclic or polycyclic, and can optionally include heteroatoms and/or one or more functional groups.

Exemplary C₂ to C₄₀ olefin monomers and optional co-monomers include ethylene, propylene, butene, pentene, hexene, heptene, octene, nonene, decene, undecene, dodecene, norbornene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, and isomers thereof, preferably hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbornene, norbornadiene, and their respective homologs and derivatives, preferably norbornene, norbornadiene, and dicyclopentadiene.

In some embodiments, one or more dienes may be present in the polymer produced herein at up to 10 weight %, preferably at 0.00001 to 1.0 weight %, preferably 0.002 to 0.5 weight %, even more preferably 0.003 to 0.2 weight %, based upon the total weight of the composition. In some embodiments, 500 ppm or less of diene is added to the polymerization, preferably 400 ppm or less, preferably or 300 ppm or less. In other embodiments, at least 50 ppm of diene is added to the polymerization, or 100 ppm or more, or 150 ppm or more.

Preferred diolefin monomers useful in various embodiments described herein can include any hydrocarbon structure, preferably C₄ to C₃₀, having at least two unsaturated bonds, where at least two of the unsaturated bonds are readily incorporated into a polymer by either a stereospecific or a non-stereospecific catalyst(s). It is further preferred that the diolefin monomers be selected from alpha, omega-diene monomers (i.e., di-vinyl monomers containing two terminal alkene groups). More preferably, the diolefin monomers are linear di-vinyl monomers, most preferably those containing from 4 to 30 carbon atoms. Examples of preferred dienes include butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, particularly preferred dienes include 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and low molecular weight polybutadienes (Mw less than 1000 g/mol). Preferred cyclic dienes include cyclopentadiene, vinylnorbornene, norbornadiene, ethylidene norbornene, divinylbenzene, dicyclopentadiene or higher ring containing diolefins with or without substituents at various ring positions.

Polymerization processes of the various embodiments described herein be carried out in any manner known in the art. Any suspension, homogeneous, bulk, solution, slurry, or gas-phase polymerization process known in the art may be used. Such processes can be run in a batch, semi-batch, or continuous mode. The term “continuous” means a system that operates without interruption or cessation. For example, a continuous process to produce a polymer or oligomer would be one where the reactants are continually introduced into one or more reactors and the polymer or oligomer product is continually withdrawn. Homogeneous polymerization processes and slurry processes can be utilized. A homogeneous polymerization process is defined to be a process where at least 90 wt % of the product is soluble in the reaction media. A bulk homogeneous process is particularly preferred. A bulk process is defined to be a process where monomer concentration in all feeds to the reactor is 70 vol % or more. Alternatively, no solvent or diluent is present or added in the reaction medium, (except for the small amounts used as the carrier for the catalyst system or other additives, or amounts typically found with the monomer (e.g., propane in propylene). Alternatively, the process may be a slurry process. As used herein the term “slurry polymerization process” means a polymerization process where a supported catalyst is employed and monomers are polymerized on the supported catalyst particles. At least 95 wt % of oligomer products derived from the supported catalyst are in granular form as solid particles (not dissolved in the diluent). A heterogeneous process is defined to be a process where the catalyst system is not soluble in the reaction media.

Other additives may also be used in the polymerization, as desired, such as one or more scavengers, promoters, modifiers, chain transfer agents (such as diethyl zinc), hydrogen, aluminum alkyls, or silanes. Useful chain transfer agents are typically alkylalumoxanes, a compound represented by the formula AlR₃, ZnR₂ (where each R is, independently, a C₁-C₈ aliphatic radical, preferably methyl, ethyl, propyl, butyl, pentyl, hexyl octyl or an isomer thereof) or a combination thereof; such as diethyl zinc, methylalumoxane, trimethylaluminum, triisobutylaluminum, trioctylaluminum, diethylaluminum chloride, ethylaluminum dichloride, or a combination thereof.

Suitable diluents/solvents for polymerization include non-coordinating, inert liquids. Examples include: straight and branched-chain hydrocarbons (e.g., isobutane, butane, pentane, isopentane, hexanes, isohexane, heptane, octane, dodecane, and/or mixtures thereof); cyclic and alicyclic hydrocarbons (e.g., cyclohexane, cycloheptane, methylcyclohexane, methylcycloheptane, and/or mixtures thereof, such as may be found commercially (Isopar™)); perhalogenated hydrocarbons (e.g., perfluorinated C₄₁₀ alkanes, chlorobenzene, and aromatic and alkyl-substituted aromatic compounds, such as benzene, toluene, mesitylene, and xylene). Suitable solvents also include liquid olefins which optionally can act as monomers or co-monomers, such as, but not limited to: ethylene, propylene, 1-butene, 1-hexene, 1-pentene, 3-methyl-1-pentene, 4-methyl-1-pentene, 1-octene, 1-decene, and/or mixtures thereof. In a preferred embodiment, aliphatic hydrocarbon solvents (e.g., isobutane, butane, pentane, isopentane, hexanes, isohexane, heptane, octane, dodecane, and/or mixtures thereof) or cyclic and alicyclic hydrocarbons (e.g., cyclohexane, cycloheptane, methylcyclohexane, methylcycloheptane, and/or mixtures thereof) can be used. In any embodiment, the solvent can be substantially absent any aromatic compounds. For example, aromatic compounds can be present in the solvent at less than 1 wt %, preferably less than 0.5 wt %, preferably less than 0 wt % based upon the weight of the solvents. In any embodiment, a feed stream can comprise a diluent/solvent from about 60 vol % or less, about 40 vol % or less, or 20 vol % or less, based on the total volume of the feed stream. This includes from 0 vol % to about 60 vol %, from about 0 vol % to about 40 vol %, and about 0 vol % to about 20 vol %. Typical temperatures and/or pressures include a temperature in the range of about 0° C. to about 300° C., preferably about 20° C. to about 200° C., preferably about 35° C. to about 150° C., preferably from about 40° C. to about 120° C., preferably from about 45° C. to about 80° C.; and at a pressure in the range of from about 0.35 MPa to about 10 MPa, preferably from about 0.45 MPa to about 6 MPa, or preferably from about 0.5 MPa to about 4 MPa.

In any of the polymerization reactions disclosed herein, the polymerization reaction conditions can include a reaction temperature from about 30° C. to about 200° C., or from about 50° C. to about 150° C., or from about 80° C. to about 140° C., or from about 90° C. to about 130° C. Alternatively, the polymerization reaction conditions can include a temperature ranging from about 30° C. or higher, or about 50° C. or higher, or about 100° C. or higher up to the boiling point of the solvent used in solution polymerization under the conditions present in the reactor.

Polymerization run times may be up to about 300 minutes, for example, in the range of from about 5 minutes to about 250 minutes, which includes from about 10 minutes to about 120 minutes. For continuous polymerization processes, the run time may correspond to a residence time in the reactor.

Processing of the oligomers can take place following the polymerization reaction. Suitable processing operations can include, but are not limited to: blending, or co-extrusion with any other polymer. Non-limiting examples of other polymers include, but are not limited to: linear low-density polyethylenes, elastomers, plastomers, high-pressure low-density polyethylene, high-density polyethylenes, polypropylenes, and/or the like. The oligomers formed according to the present disclosure can also be blended with additives to form compositions that may then be used in articles of manufacture. Suitable additives can include, but are not limited to: antioxidants, nucleating agents, acid scavengers, plasticizers, stabilizers, anticorrosion agents, blowing agents, ultraviolet light absorbers, quenchers, antistatic agents, slip agents, phosphites, phenolics, pigments, dyes and fillers and cure agents such as peroxide.

In various embodiments, hydrogen can be included in the polymerization reaction conditions to provide increased activity without significantly impairing the catalytic activity of the metal-ligand complexes. Catalyst activity (e.g., calculated as g/mmol catalyst/hour) can be at least 20% higher than the same reaction without hydrogen present, which includes at least 50% higher and at least 100% higher. The activity of the catalyst may be at least 50 g/mmol/hour, at least about 500 g/mmol/hour, at least about 5,000 g/mmol/hour, or at least about 50,000 g/mmol/hour. The conversion of an olefinic feed, based upon oligomer yield and the weight of the olefin monomer entering the reaction zone, can be at least about 10%, at least about 20%, at least about 30%, at least about 50%, or at least about 80%.

In a preferred embodiment, the polymerization: 1) is conducted at temperatures of 0° C. to 300° C. (preferably 25° C. to 150° C., preferably 40° C. to 120° C., preferably 45° C. to 80° C.); 2) is conducted at a pressure of atmospheric pressure to 10 MPa (preferably 0.35 MPa to 10 MPa, preferably from 0.45 MPa to 6 MPa, preferably from 0.5 MPa to 4 MPa); 3) is conducted in an aliphatic hydrocarbon solvent (such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof; preferably where aromatics are preferably present in the solvent at less than 1 wt %, preferably less than 0.5 wt %, preferably at 0 wt % based upon the weight of the solvents); 4) includes a catalyst system in the polymerization that comprises less than 0.5 mol %, preferably 0 mol % alumoxane, alternately the alumoxane is present at a molar ratio of aluminum to transition metal less than 500:1, preferably less than 300:1, preferably less than 100:1, preferably less than 1:1; 5) the polymerization preferably occurs in one reaction zone; 6) the productivity of the catalyst compound is at least 80,000 g/mmol/hr (preferably at least 150,000 g/mmol/hr, preferably at least 200,000 g/mmol/hr, preferably at least 250,000 g/mmol/hr, preferably at least 300,000 g/mmol/hr); 7) optionally scavengers (such as trialkyl aluminum compounds) are absent (e.g. present at zero mol %, alternately the scavenger is present at a molar ratio of scavenger metal to transition metal of less than 100:1, preferably less than 50:1, preferably less than 15:1, preferably less than 10:1); and 8) optionally hydrogen is present in the polymerization reactor at a partial pressure of 0.001 psig to 50 psig (0.007 psig to 345 kPa) (preferably from 0.01 psig to 25 psig (0.07 kPa to 172 kPa), more preferably 0.1 psig to 10 psig (0.7 kPa to 70 kPa)). In a preferred embodiment, the catalyst system used in the polymerization comprises no more than one catalyst compound. A “reaction zone” also referred to as a “polymerization zone” is a vessel where polymerization takes place, for example a batch reactor. When multiple reactors are used in either series or parallel configuration, each reactor is considered as a separate polymerization zone. For a multi-stage polymerization in both a batch reactor and a continuous reactor, each polymerization stage is considered as a separate polymerization zone. In a preferred embodiment, the polymerization occurs in one reaction zone. Room temperature is 23° C. unless otherwise noted.

Polymerization of an olefinic feed stream may be carried out in a reaction zone within a reactor. A system can include multiple reactors and/or multiple reaction zones. A reactor can be a batch reactor, a semi-batch reactor, or a continuous reactor. Examples of suitable continuous reactors include, but are not limited to: continuous stirred tanks (and trains thereof), loop-type reactors, fluidized bed reactors, a combination thereof, and/or the like. Multiple reactors can be in series or in parallel. A reactor can include at least one reaction zone comprising one or more metal-ligand complexes containing a ligand represented by Formula 1 as a polymerization catalyst. A reactor may further include at least one inlet, configured and arranged to receive a feed stream and at least one outlet, configured and arranged to receive a product stream. In any embodiment where two or more different alpha olefins are reacted, a reactor may include additional inlets for receiving a stream comprising additional monomers. A reactor can further comprise one or more additional inlets for introducing one or more of a catalyst (e.g., one or more of the metal-ligand complexes described herein), diluent, or any other material, for example, a hydrogen stream, and/or a catalyst poison, into the reactor. A system can also comprise conduits for conveying spent catalyst to a catalyst regeneration system. A system comprising a reactor may also comprise equipment, processors, and controls for regulating various reactor conditions including, but not limited to, pressure, temperature, and flow rate. A system comprising a reactor can also comprise equipment and plumbing to recycle unused monomer, process gas, hydrogen, or any combination thereof, back into the system. One of ordinary skill in the art will be able to employ the catalyst systems disclosed herein to generate a product stream comprising a high yield of PAOs using reactors and equipment well known in the art without undue experimentation.

The PAOs prepared herein can be functionalized by reacting a heteroatom-containing group (e.g., amines, aldehydes, alcohols, acids, succinic acid, maleic acid, maleic anhydride) with the allyl group of the polymer, with or without a catalyst. Examples include, but are not limited to, catalytic hydrosilylation, hydroformylation, hydroboration, epoxidation, hydration, dihydroxylation, hydroamination, or maleation with or without activators such as free radical generators (e.g., peroxides). Functionalized PAOs can be used as oil additives and many other applications, for example, additives for lubricants and/or fuels.

Any olefinic feed may be polymerized using the catalyst systems disclosed herein. Suitable olefinic feeds may include any C₂-C₄₀ alpha olefin, preferably a C₃-C₃₂ alpha olefin, optionally in further combination with ethylene, which may be straight chain or branched, cyclic or acyclic, optionally containing heteroatom substitution. For example, the olefinic feed may comprise one or more of a C₃ alpha olefin, C₄ alpha olefin, C₅ alpha olefin, C₆ alpha olefin, C₇ alpha olefin, C₈ alpha olefin, C₉ alpha olefin, C₁₀ alpha olefin, C₁₁ alpha olefin, C₁₂ alpha olefin, C₁₃ alpha olefin, C₁₄ alpha olefin, C₁₅ alpha olefin, C₁₆ alpha olefin, C₁₇ alpha olefin, C₁₈ alpha olefin, C₁₉ alpha olefin, C₂₀ alpha olefin, C₂₁ alpha olefin, C₂₂ alpha olefin, C₂₃ alpha olefin, C₂₄ alpha olefin, C₂₅ alpha olefin, C₂₆ alpha olefin, C₂₇ alpha olefin, C₂₈ alpha olefin, C₂₉ alpha olefin, C₃₀ alpha olefin, C₃₁ alpha olefin, C₃₂ alpha olefin, C₃₃ alpha olefin, C₃₄ alpha olefin, C₃₅ alpha olefin, C₃₆ alpha olefin, C₃₇ alpha olefin, C₃₈ alpha olefin, C₃₉ alpha olefin, and a C₄₀ alpha olefin. In more specific embodiments, the olefinic feed may comprise a C₂-C₁₂ alpha olefin such as, for example, ethylene, propylene, 1-butene, 1-pentene, 1-hexene, 1-heptene, 1-octene, 1-nonene, 1-decene, 1-undecene, 1-dodecene, or any combination thereof. For example, combinations of propylene and 1-decene may be used. Alternately, 1-decene may be utilized without any co-monomer. The olefinic feed may comprise any single alpha olefin or any mixture of one or more of the foregoing alpha olefins.

By contacting an olefinic feed with a metal-ligand complex as described herein, a plurality of PAOs comprising mer units derived from the alpha olefins in the olefinic feed may be produced.

For example, in any embodiment, the processes described herein can be used to produce a plurality of vinyl-terminated PAOs from a single alpha olefin (a PAO homopolymer). Examples of vinyl-terminated PAO homopolymers that can be generated include homopolymers comprising a C₂ to C₄₀ alpha olefin, more preferably a C₃ to C₂₀ alpha olefin, and still more preferably an oligomer of 1-decene.

In any embodiment, the processes described herein may be used to produce a plurality of PAOs from two, three, four, or more C₂ to C₄₀ alpha olefins (a PAO copolymer). In any embodiment, suitable C₂ to C₄₀ alpha olefins can include two or more of ethylene, propylene, 1-butene, 1-pentene, 1-hexene, 1-heptene, 1-octene, 1-nonene, 1-decene, 1-undecene, and 1-dodecene. Preferably, a PAO copolymer comprises propylene and 1-decene.

Accordingly, polymerization methods described herein can comprise contacting a catalyst system of the present disclosure with an olefinic feed comprising a C₂-C₃₂ alpha olefin, preferably a C₂ to C₂₀ alpha olefin or any combination thereof, under polymerization reaction conditions. In the present disclosure, ethylene is considered to be an alpha olefin.

Oligomers (or polymers) produced using the metal-ligand complexes and polymerization reactions of the present disclosure may be characterized by a range of physical property measurements, as discussed hereinafter.

In any embodiment, the catalyst systems of the present disclosure may be capable of producing a plurality of PAOs having a density, as determined by ASTM D 1505-18, ranging from about 0.86 g/cc to about 0.97 g/cc, about 0.90 g/cc to about 0.950 g/cc, about 0.905 g/cc to about 0.940 g/cc, or about 0.910 g/cc to about 0.930 g/cc.

In any embodiment, the catalyst systems of the present disclosure may be capable of producing a plurality of PAOs having a number average molecular weight (Mn), as determined by ¹H NMR, of at least about 500 g/mol, which includes about 500 g/mol to about 60,000 g/mol, about 500 g/mol to about 50,000 g/mol, about 500 g/mol to about 35,000 g/mol, about 500 g/mol to about 15,000 g/mol, about 500 g/mol to about 12,000 g/mol, or about 500 g/mol to about 10,000 g/mol.

In any embodiment, the catalyst systems of the present disclosure may be capable of producing a plurality of PAOs having a ratio of weight average molecular weight to number average molecular weight (Mw/Mn), as determined by ¹H NMR, of about 1.5 to about 10, about 2.0 to about 10, about 2.2 to about 8, about 2.4 to about 7, or about 2.5 to about 6.

In any embodiment, the catalyst systems of the present disclosure may be capable of producing a plurality of PAOs having a ratio of z-average molecular weight to number average molecular weight (Mz/Mn), as determined by ¹H NMR, of 10 or greater, which includes from about 10 to about 50, from about 12 to about 45, and from about 15 to about 40.

In any embodiment, the catalyst systems of the present disclosure may be capable of producing a plurality of PAOs having a melting point (Tm), as determined by differential scanning calorimetry, of about 100° C. to about 200° C., about 45° C. to about 135° C., about 80° C. to about 130° C., or about 115° C. to about 135° C.

Unless otherwise specified, analytical testing of polymer samples was conducted in accordance with the following procedure. For analytical testing, polymer sample solutions were prepared by dissolving the polymer in 1,2,4-trichlorobenzene (TCB, 99+% purity from Sigma-Aldrich) containing 2,6-di-tert-butyl-4-methylphenol (BHT, 99% from Aldrich) at 165° C. in a shaker oven for approximately 3 hours. The typical concentration of polymer in solution was between 0.1 to 0.9 mg/mL with a BHT concentration of 1.25 mg BHT/mL of TCB. Samples were cooled to 135° C. for testing.

High-temperature size exclusion chromatography was performed using an automated “Rapid GPC” system as described in U.S. Pat. Nos. 6,491,816; 6,491,823; 6,475,391; 6,461,515; 6,436,292; 6,406,632; 6,175,409; 6,454,947; 6,260,407; and 6,294,388; each of which is incorporated herein by reference. Molecular weights (weight average molecular weight (Mw) and number average molecular weight (Mn)) and molecular weight distribution (MWD=Mw/Mn), which is also sometimes referred to as the polydispersity index (PDI) of the polymer, were measured by Gel Permeation Chromatography using a Symyx Technology GPC equipped with evaporative light scattering detector (ELSD) and calibrated using polystyrene standards (Polymer Laboratories: Polystyrene Calibration Kit S-M-10: Mp (peak Mw) between 5,000 and 3,390,000). Alternatively, samples were measured by Gel Permeation Chromatography using a Symyx Technology GPC equipped with dual wavelength infrared detector and calibrated using polystyrene standards (Polymer Laboratories: Polystyrene Calibration Kit S-M-10: Mp (peak Mw) between 580 and 3,039,000). Samples (250 μL of a polymer solution in TCB were injected into the system) were run at an eluent flow rate of 2.0 mL/minute (135° C. sample temperatures, 165° C. oven/columns) using three Polymer Laboratories: PLgel 10 μm Mixed-B 300×7.5 mm columns in series. No column spreading corrections were employed. Numerical analyses were performed using Epoch® software available from Symyx Technologies or Automation Studio software available from Freeslate. The molecular weights obtained are relative to linear polystyrene standards.

Differential Scanning calorimetry (DSC) measurements were performed on a TA-Q100 instrument to determine the melting point of the polymers. Samples were pre-annealed at 220° C. for 15 minutes and then allowed to cool to room temperature overnight. The samples were then heated to 220° C. at a rate of 100° C./minute and then cooled at a rate of 50° C./minute. Melting points [Tm (° C.)] were collected during the heating period.

Samples for infrared analysis were prepared by depositing the stabilized polymer solution onto a silanized wafer. By this method, approximately between 0.12 mg and 0.24 mg of polymer is deposited on the wafer cell. The samples were subsequently analyzed on a Bruker Equinox 55 FTIR spectrometer equipped with Pikes' MappIR specular reflectance sample accessory. Spectra, covering a spectral range of 5000 cm⁻¹ to 500 cm⁻¹, were collected at a 2 cm⁻¹ resolution with 32 scans. For ethylene-1-octene copolymers, the wt % octene in the copolymer was determined via measurement of the methyl deformation band at ˜1375 cm⁻¹. The peak height of this band was normalized by the combination and overtone band at ˜4321 cm⁻¹, which corrects for path length differences. The normalized peak height was correlated to individual calibration curves from ¹H NMR data to predict the wt % octene content within a concentration range of ˜2 wt % to 35 wt % for octene. Typically, R² correlations of 0.98 or greater are achieved.

Polymers synthesized in accordance with the various embodiments described herein (e.g., polyethylene and/or polypropylene polymers) can be combined with one or more additional polymers prior to being formed into a film, molded part or other article. Other useful polymers include polyethylene, isotactic polypropylene, highly isotactic polypropylene, syndiotactic polypropylene, random copolymer of propylene and ethylene, and/or butene, and/or hexene, polybutene, ethylene vinyl acetate, LDPE, LLDPE, HDPE, ethylene vinyl acetate, ethylene methyl acrylate, copolymers of acrylic acid, polymethylmethacrylate or any other polymers polymerizable by a high-pressure free radical process, polyvinylchloride, polybutene-1, isotactic polybutene, ABS resins, ethylene-propylene rubber (EPR), vulcanized EPR, EPDM, block copolymer, styrenic block copolymers, polyamides, polycarbonates, PET resins, cross linked polyethylene, copolymers of ethylene and vinyl alcohol (EVOH), polymers of aromatic monomers such as polystyrene, poly-1 esters, polyacetal, polyvinylidine fluoride, polyethylene glycols, and/or polyisobutylene.

Additionally one or more polymers synthesized in accordance with the various embodiments described herein can be comprised within a polymer blend at from 10 wt % to 99 wt %, based upon the weight of the polymers in the blend, preferably 20 wt % to 95 wt %, even more preferably at least 30 wt % to 90 wt %, even more preferably at least 40 wt % to 90 wt %, even more preferably at least 50 wt % to 90 wt %, even more preferably at least 60 wt % to 90 wt %, even more preferably at least 70 wt % to 90 wt %.

The blends described above may be produced by mixing the polymers described herein (e.g., synthesized using one or more of the metal-ligand complexes described herein as a catalyst) with one or more polymers (as described above), by connecting reactors together in series to make reactor blends or by using more than one catalyst in the same reactor to produce multiple species of polymer. The polymers can be mixed together prior to being put into the extruder or may be mixed in an extruder.

The blends may be formed using conventional equipment and methods, such as by dry blending the individual components and subsequently melt mixing in a mixer, or by mixing the components together directly in a mixer, such as, for example, a Banbury mixer, a Haake mixer, a Brabender internal mixer, or a single or twin-screw extruder, which may include a compounding extruder and a side-arm extruder used directly downstream of a polymerization process, which may include blending powders or pellets of the resins at the hopper of the film extruder. Additionally, additives may be included in the blend, in one or more components of the blend, and/or in a product formed from the blend, such as a film, as desired. Such additives are well known in the art, and can include, for example: fillers; antioxidants (e.g., hindered phenolics such as IRGANOX™ 1010 or IRGANOX™ 1076 available from Ciba-Geigy); phosphites (e.g., IRGAFOS™ 168 available from Ciba-Geigy); anti-cling additives; tackifiers, such as polybutenes, terpene resins, aliphatic and aromatic hydrocarbon resins, alkali metal and glycerol stearates, and hydrogenated rosins; UV stabilizers; heat stabilizers; anti-blocking agents; release agents; anti-static agents; pigments; colorants; dyes; waxes; silica; fillers; talc; and the like.

Specifically, any of the foregoing polymers, such as the foregoing polypropylenes or blends thereof, may be used in a variety of end-use applications. Such applications include, for example, mono- or multi-layer blown, extruded, and/or shrink films. These films may be formed by any number of well-known extrusion or co-extrusion techniques, such as a blown bubble film processing technique, wherein the composition can be extruded in a molten state through an annular die and then expanded to form a uni-axial or biaxial orientation melt prior to being cooled to form a tubular, blown film, which can then be axially slit and unfolded to form a flat film. Films may be subsequently unoriented, uniaxially oriented, or biaxially oriented to the same or different extents. One or more of the layers of the film may be oriented in the transverse and/or longitudinal directions to the same or different extents. The uniaxially orientation can be accomplished using typical cold drawing or hot drawing methods. Biaxial orientation can be accomplished using tenter frame equipment or a double bubble processes and may occur before or after the individual layers are brought together. For example, a polyethylene layer can be extrusion coated or laminated onto an oriented polypropylene layer or the polyethylene and polypropylene can be coextruded together into a film then oriented. Likewise, oriented polypropylene could be laminated to oriented polyethylene or oriented polyethylene could be coated onto polypropylene then optionally the combination could be oriented even further. Typically the films are oriented in the Machine Direction (MD) at a ratio of up to 15, preferably between 5 and 7, and in the Transverse Direction (TD) at a ratio of up to 15, preferably 7 to 9. However, in another embodiment the film is oriented to the same extent in both the MD and TD directions.

The films may vary in thickness depending on the intended application; however, films of a thickness from 1 to 50 μm are usually suitable. Films intended for packaging are usually from 10 to 50 μm thick. The thickness of the sealing layer is typically 0.2 to 50 μm. There may be a sealing layer on both the inner and outer surfaces of the film or the sealing layer may be present on only the inner or the outer surface.

In another embodiment, one or more layers may be modified by corona treatment, electron beam irradiation, gamma irradiation, flame treatment, or microwave. In a preferred embodiment, one or both of the surface layers is modified by corona treatment.

Embodiments disclosed herein include:

A. Metal-ligand complexes. The metal-ligand complexes comprise a transition metal atom or a lanthanide metal atom and a ligand having a structure presented by Formula 1.

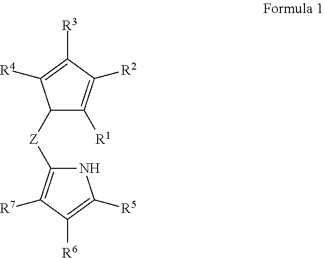

wherein:
   R¹ and R² are independently hydrogen or a C₁-C₁₄ hydrocarbyl group;
   R³ and R⁴ are independently hydrogen or a C₁-C₁₄ hydrocarbyl group, or R³ and R⁴ are joined together to form an optionally substituted 6-membered aromatic ring;
   R⁵ is hydrogen, C₁-C₁₀ alkyl, C₃-C₁₀ cycloalkyl, C₆-C₃₀ aryl, a heteroaryl group, or CN, provided that R⁵ is C₃-C₁₀ cycloalkyl, C₆-C₃₀ aryl, a heteroaryl group, or CN if the transition metal atom is Ti or Zr and R³ and R⁴ are joined together to form a 6-membered aromatic ring;
   R⁶ and R⁷ are independently hydrogen or a C₁-C₁₄ hydrocarbyl group; and
   Z is a bridging atom.

B. Catalyst systems. The catalyst systems comprise: at least one activator; and
a metal-ligand complex comprising a transition metal atom or a lanthanide metal atom and a ligand having a structure represented by Formula 1.

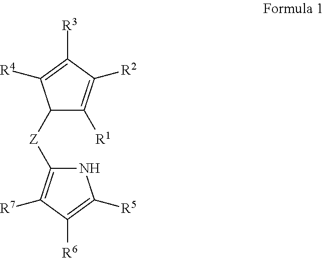

wherein:
R¹ and R² are independently hydrogen or a C₁-C₁₄ hydrocarbyl group;
R³ and R⁴ are independently hydrogen or a C₁-C₁₄ hydrocarbyl group, or R³ and R⁴ are joined together to form an optionally substituted 6-membered aromatic ring;
R⁵ is hydrogen, C₁-C₁₀ alkyl, C₃-C₁₀ cycloalkyl, C₆-C₃₀ aryl, a heteroaryl group, or CN, provided that R⁵ is C₃-C₁₀ cycloalkyl, C₆-C₃₀ aryl, a heteroaryl group, or CN if the transition metal atom is Ti or Zr and R³ and R⁴ are joined together to form a 6-membered aromatic ring;
R⁶ and R⁷ are independently hydrogen or a C₁-C₁₄ hydrocarbyl group; and
Z is a bridging atom.

C. Polymerization methods. The methods comprise: providing an olefinic feed; and contacting the catalyst system of B with the olefinic feed under polymerization reaction conditions.

Embodiments A-C can have one or more of the following additional elements in any combination:

Element 1: wherein the metal-ligand complex has a structure represented by Formula 1A

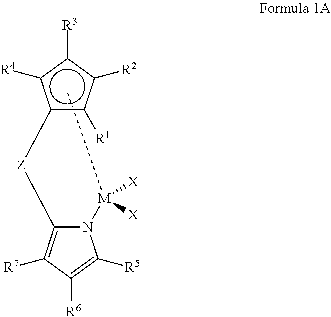

wherein:
   M is the transition metal atom or the lanthanide metal atom; and
   X is independently a leaving group, or two Xs are joined and bound to M to form a metallocycle ring, a chelating ligand, a diene ligand, or an alkylidene.

Element 2: wherein each X independently comprises a C₁-C₂₀ hydrocarbyl group, a hydride, an alkoxide, a sulfide, a phosphide, a halide, a diene, an amine, a phosphine, an ether, or any combination thereof.

Element 3: wherein each X is dimethylamido or bis(dimethylsilylamido).

Element 4: wherein M is a Group 4 transition metal, a lanthanide, or chromium.

Element 5: wherein M is hafnium, chromium, neodymium, or lanthanum.

Element 6: wherein the metal-ligand complex has a structure represented by one or more of Formulas 3-5,

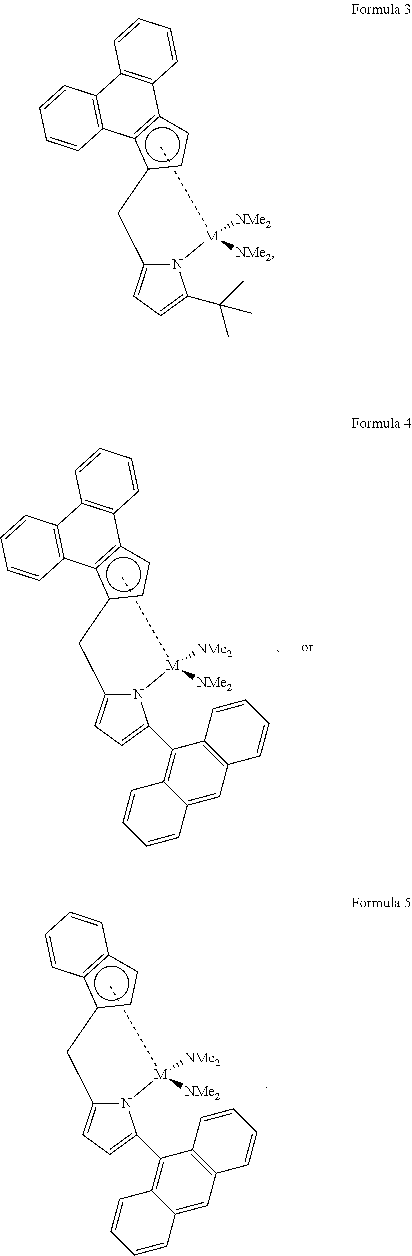

Element 7: wherein Z is CH₂.

Element 8: wherein the metal-ligand complex further comprises a solvent or a Lewis base complexed to the transition metal atom or the lanthanide metal atom as a second ligand.

Element 9: wherein R¹, R², R⁶, and R⁷ are independently hydrogen, C₁-C₁₀ alkyl, or C₆-C₁₀ aryl.

Element 10: wherein R¹ and R² are independently hydrogen, methyl, or optionally substituted phenyl.

Element 11: wherein R⁶ and R⁷ are both H.

Element 12: wherein R³ and R⁴ are independently hydrogen, C₁-C₁₀ alkyl, or C₆-C₁₀ aryl.

Element 13: wherein R³ and R⁴ are independently hydrogen, methyl, or optionally substituted phenyl.

Element 14: wherein R³ and R⁴ are not joined together to form an optionally substituted 6-membered aromatic ring.

Element 15: wherein R³ and R⁴ are joined together to form an optionally substituted 6-membered aromatic ring, and R⁵ is C₁-C₁₀ alkyl or C₆-C₃₀ aryl.

Element 16: wherein R⁵ is t-butyl or optionally substituted phenyl.

Element 17: wherein the at least one activator comprises an alumoxane, a non-coordinating anion, or any combination thereof.

By way of non-limiting example, exemplary combinations applicable to A, B, and C include, but are not limited to: 1, and 2 or 3; 1, 2 or 3, and 4; 1 and 6; 1, 2 or 3, and 7; 1, 2 or 3, and 8; 1, 2 or 3, and 8; 1, 2 or 3, 5, and 8; 1 and 9; 1, 7, and 9; 1, 4, 7, and 9; 1, 4, and 10; 1, 7, and 11; 1, 4, 7, and 11; 1, 7, and 12; 1, 4, 7, and 12; 1, 7, 9, and 12 or 13; 1, 4, 7, 9, and 12 or 13; 1, 7, and 14; 1, 4, 7, and 14; 1, 7, and 15 or 16; 1, 4, 7, and 15 or 16; 2 or 3, and 4 or 5; 2 or 3, and 7; 2 or 3, and 8; 2 or 3, and 9; 2 or 3, and 4; 2 or 3, 4, and 10; 2 or 3, and 11; 2 or 3, 4, and 11; 2 or 3, and 12 or 13; 2 or 3, 4, and 12 or 13; 2 or 3, and 14; 2 or 3, 4, and 14; 2 or 3, and 15; 2 or 3, 4, and 15; 4 and 6; 4 and 7; 4 and 8; 4 and 9; 4 and 10; 4, 10, and 11; 4 and 11; 4, and 12 or 13; 4 and 14; 4 and 15; 7, and 9 or 10; 7, 9 or 10, and 11; 7, and 12 or 13; 7, and 9, 10, or 11, and 12 or 13; 7 and 14; 7 and 15; 9 and 10; 9 and 11; 9, and 12 or 13; 9, 11, and 12 or 13; 9 and 14; 9 and 15; 10 and 11; 10, and 12 or 13; 10, 11, and 12 or 13; 10 and 14; and 10 and 15. Any of the foregoing may occur in further combination with 16. With respect to B, any of the foregoing may be in further combination with 17.

The present disclosure further relates to the following non-limiting clauses:

Clause 1. A metal-ligand complex comprising a transition metal atom or a lanthanide metal atom and a ligand having a structure represented by Formula 1

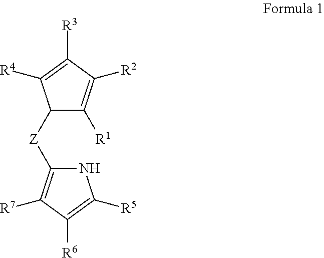

wherein:
   R¹ and R² are independently hydrogen or a C₁-C₁₄ hydrocarbyl group;
   R³ and R⁴ are independently hydrogen or a C₁-C₁₄ hydrocarbyl group, or R³ and R⁴ are joined together to form an optionally substituted 6-membered aromatic ring;
   R⁵ is hydrogen, C₁-C₁₀ alkyl, C₃-C₁₀ cycloalkyl, C₆-C₃₀ aryl, a heteroaryl group, or CN, provided that R⁵ is C₃-C₁₀ cycloalkyl, C₆-C₃₀ aryl, a heteroaryl group, or CN if the transition metal atom is Ti or Zr and R³ and R⁴ are joined together to form a 6-membered aromatic ring;
   R⁶ and R⁷ are independently hydrogen or a C₁-C₁₄ hydrocarbyl group; and
   Z is a bridging atom.

Clause 2. The metal-ligand complex of clause 1, wherein the metal-ligand complex has a structure represented by Formula 1A

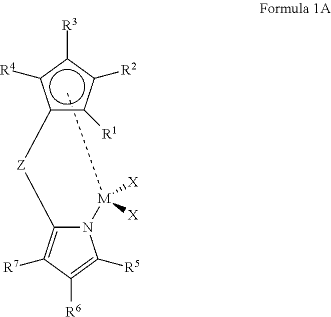

wherein:
   M is the transition metal atom or the lanthanide metal atom; and
   X is independently a leaving group, or two Xs are joined and bound to M to form a metallocycle ring, a chelating ligand, a diene ligand, or an alkylidene.

Clause 3. The metal-ligand complex of clause 2, wherein each X independently comprises a C₁-C₂₀ hydrocarbyl group, a hydride, an alkoxide, a sulfide, a phosphide, a halide, a diene, an amine, a phosphine, an ether, or any combination thereof.

Clause 4. The metal-ligand complex of clause 2 or clause 3, wherein each X is dimethylamido or bis(dimethylsilylamido).

Clause 5. The metal-ligand complex of any one of clauses 2-4, wherein M is a Group 4 transition metal, a lanthanide, or chromium.

Clause 6. The metal-ligand complex of any one of clauses 2-5, wherein M is hafnium, chromium, neodymium, or lanthanum.

Clause 7. The metal-ligand complex of any one of clauses 2-6, wherein the metal-ligand complex has a structure represented by one or more of Formulas 3-5,

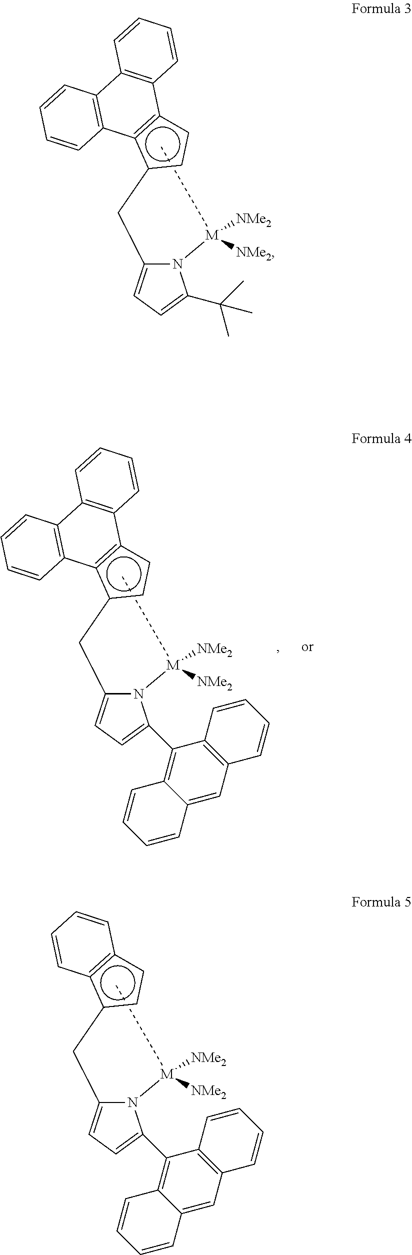

Clause 8. The metal-ligand complex of any one of clauses 1-7, wherein Z is CH₂.

Clause 9. The metal-ligand complex of clause 1, further comprising:
a solvent or a Lewis base complexed to the transition metal atom or the lanthanide metal atom as a second ligand.

Clause 10. The metal-ligand complex of any one of clauses 1-9, wherein R¹, R², R⁶, and R⁷ are independently hydrogen, C₁-C₁₀ alkyl, or C₆-C₁₀ aryl.

Clause 11. The metal-ligand complex of any of clauses 1-10, wherein R¹ and R² are independently hydrogen, methyl, or optionally substituted phenyl.

Clause 12. The metal-ligand complex of any one of clauses 1-11, wherein R⁶ and R⁷ are both H.

Clause 13. The metal-ligand complex of any one of clauses 1-12, wherein R³ and R⁴ are independently hydrogen, C₁-C₁₀ alkyl, or C₆-C₁₀ aryl.

Clause 14. The metal-ligand complex of any one of clauses 1-13, wherein R³ and R⁴ are independently hydrogen, methyl, or optionally substituted phenyl.

Clause 15. The metal-ligand complex of any one of clauses 1-14, wherein R³ and R⁴ are not joined together to form an optionally substituted 6-membered aromatic ring.

Clause 16. The metal-ligand complex of any one of clauses 1-12, wherein R³ and R⁴ are joined together to form an optionally substituted 6-membered aromatic ring, and R⁵ is C₁-C₁₀ alkyl or C₆-C₃₀ aryl.

Clause 17. The metal-ligand complex of any one of clauses 1-16, wherein R⁵ is t-butyl or optionally substituted phenyl.

Clause 18. A catalyst system comprising:
at least one activator; and
a metal-ligand complex comprising a transition metal atom or a lanthanide metal atom and a ligand having a structure represented by Formula 1

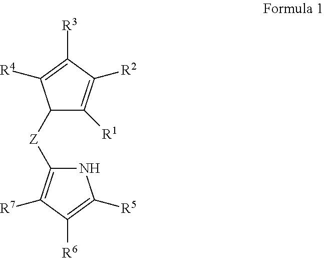

wherein:
R¹ and R² are independently hydrogen or a C₁-C₁₄ hydrocarbyl group;
R³ and R⁴ are independently hydrogen or a C₁-C₁₄ hydrocarbyl group, or R³ and R⁴ are joined together to form an optionally substituted 6-membered aromatic ring;
R⁵ is hydrogen, C₁-C₁₀ alkyl, C₃-C₁₀ cycloalkyl, C₆-C₃₀ aryl, a heteroaryl group, or CN, provided that R⁵ is C₃-C₁₀ cycloalkyl, C₆-C₃₀ aryl, a heteroaryl group, or CN if the transition metal atom is Ti or Zr and R³ and R⁴ are joined together to form a 6-membered aromatic ring;
R⁶ and R⁷ are independently hydrogen or a C₁-C₁₄ hydrocarbyl group; and
Z is a bridging atom.

Clause 19. The catalyst system of clause 18, wherein the metal-ligand complex has a structure represented by Formula 1A

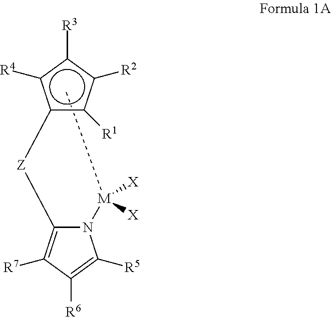

wherein:
   M is the transition metal atom or the lanthanide metal atom; and
   X is independently a leaving group, or two Xs are joined and bound to M to form a metallocycle ring, a chelating ligand, a diene ligand, or an alkylidene.

Clause 20. The catalyst system of clause 19, wherein each X independently comprises a C₁-C₂₀ hydrocarbyl group, a hydride, an alkoxide, a sulfide, a phosphide, a halide, a diene, an amine, a phosphine, an ether, or any combination thereof.

Clause 21. The catalyst system of clause 19 or clause 20, wherein each X is dimethylamido or bis(dimethylsilylamido).

Clause 22. The catalyst system of any one of clauses 19-21, wherein Mis a Group 4 transition metal, a lanthanide, or chromium.

Clause 23. The catalyst system of any one of clauses 19-22, wherein Mis hafnium, chromium, neodymium, or lanthanum.

Clause 24. The catalyst system of any one of clauses 18-23, wherein Z is CH₂.

Clause 25. The catalyst system of any one of clauses 18-24, wherein R¹, R², R⁵, and R⁶ are independently hydrogen, C₁-C₁₀ alkyl, or C₆-C₁₀ aryl.

Clause 26. The catalyst system of any one of clauses 18-25, wherein R³ and R⁴ are independently hydrogen, C₁-C₁₀ alkyl, or C₆-C₁₀ aryl.

Clause 27. The catalyst system of any one of clauses 18-26, wherein R³ and R⁴ are not joined together to form an optionally substituted 6-membered aromatic ring.

Clause 28. The catalyst system of any one of clauses 18-25, wherein R³ and R⁴ are joined together to form an optionally substituted 6-membered aromatic ring, and R⁵ is C₁-C₁₀ alkyl or C₆-C₃₀ aryl.

Clause 29. The catalyst system of any one of clauses 18-28, wherein the at least one activator comprises an alumoxane, a non-coordinating anion, or any combination thereof.

Clause 30. A method comprising:
providing an olefinic feed; and
contacting the catalyst system of any one of clauses 18-28 with the olefinic feed under polymerization reaction conditions.

To facilitate a better understanding of the embodiments described herein, the following examples of various representative embodiments are given. In no way should the following examples be read to limit, or to define, the scope of the present disclosure.

### EXAMPLES

Representative syntheses for ligands and metal-ligand complexes follow. Polymerization reactions using the metal-ligand complexes are described in further detail below.

### Synthesis of Ligands

### Example 1: Synthesis of 2-(tert-Butyl)-5-{(tetracyclo[11.4.0.0^{2,6}.0^{7,12}]heptadeca-1,3,6,8,10,12,14,16-octaen-3-yl)methyl}pyrrole (Formula 3)

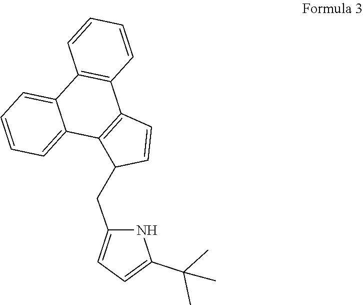 [SMILES: CC(C)(C)c1ccc(CC2C=Cc3c2c2ccccc2c2ccccc32)[nH]1]

1H-cyclopenta[l]phenanthrene (2.535 g) and 5-tert-butyl-1H-pyrrole-2-carbaldehyde (3.626 g) were dissolved in 1% KOH-ethanol (60 mL) and the mixture was heated to reflux for two days. The color of the reaction deepened and ranged from orange to red. The solvent was reduced and then the reaction mixture was cooled to room temperature. The mixture was taken up into dichloromethane and washed with water and brine. The organics were collected, dried with MgSO₄, and filtered. The solvent was removed and the resulting residue was carried to the next step without further purification. The compound was dissolved in 25 mL of tetrahydrofuran and cooled to −20° C. LiAlH₄ (1.909 g) was added as a powder, and the reaction was left to stir overnight. Further, the reaction was cooled to 0° C. and quenched with ice water. The mixture was extracted with diethyl ether (3×50 mL), and the combined organics were washed with water and brine, dried over MgSO₄, and filtered. TLC in 10% EtOAc/Hex was taken of the solution and showed good separation with some immobile material. After column chromatography (5-20% EtAcO/Hex), 2.15 g (37%) of the title compound ligand was collected.

### Example 2: Synthesis of 2-(9-Anthryl)-5-{(tetracyclo[11.4.0.0^{2,6}.0^{7,12}]heptadeca-1,3,6,8,10,12,14,16-octaen-3-yl)methyl}pyrrole (Formula 4)

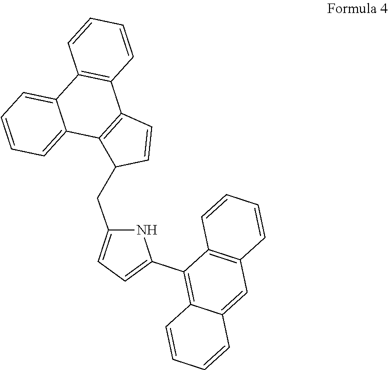 [SMILES: C1=CC(Cc2ccc(-c3c4ccccc4cc4ccccc34)[nH]2)c2c1c1ccccc1c1ccccc21]

Pyrrolidene (281 mg) was added to a cold 5 mL methanol solution of 5-(anthracen-9-yl)-1H-pyrrole-2-carbaldehyde (535 mg) and 1H-cyclopenta[1]phenanthrene (426 mg). The solution was warmed to room temperature and stirred for 2.5 hours while slowly turning orange. The solution was cooled on ice and acetic acid was added at 0° C. followed by addition of cold 10 mL DCM and 1 mL water. The solids were stirred for 15 minutes at room temperature. The organics were separated by dichloromethane extraction. The organic layer was separated, stirred over MgSO₄, and filtered through Celite. The solvent was then removed. The remaining solids were stirred and washed with minimum hexane and diethyl ether to isolate a fulvene intermediate as a red powder. The compound was washed with ether and hexane one more time and dried to afford 800 mg of the fulvene intermediate. Reduction was carried as described above for Formula 3 using LiAlH₄ and 237 mg fulvene intermediate to obtain the title compound (164 mg).

### Example 3: Synthesis of 2-(9-Anthryl)-5-[(1H-inden-3-yl)methyl]pyrrole (Formula 5)

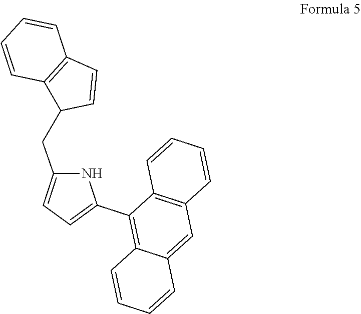 [SMILES: C1=CC(Cc2ccc(-c3c4ccccc4cc4ccccc34)[nH]2)c2ccccc21]

The title compound was obtained in a similar manner to that described for Formula 4 in Example 2, except indene was substituted for 1H-cyclopenta[1]phenanthrene.

### Example 4: Synthesis of 2-methyl-5-((4,5,6,7-tetramethyl-1H-inden-1-yl)methyl)-1H-pyrrole (Formula 6)

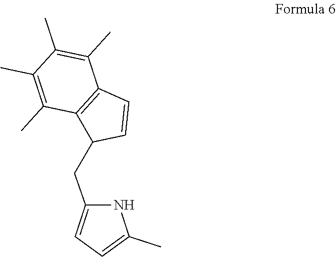

To a cold 5 mL methanol solution of 5-methyl-1H-pyrrole-2-carbaldehyde (535 mg) and 4,5,6,7-tetramethyl-1H-indene (426 mg), pyrrolidene (281 mg) and acetic acid (599 mg) were added. The solution was warmed to room temperature and stirred for 2.5 hours, during which time the reaction mixture slowly turned orange. The solution was cooled on ice and acetic acid was added at 0° C., followed by 10 mL of cold dichloromethane and 1 mL water. The resulting solids were stirred for 15 minutes at room temperature. The organics were separated by dichloromethane extraction, and the dicloromethane extracts were stirred over MgSO₄ and filtered through Celite. The solvent was removed, and the remaining solids were stirred and washed with minimum hexane and diethyl ether to isolate a fulvene intermediate as a red powder which was used without further purification.

The fulvene intermediate was dissolved in 25 mL of tetrahydrofuran and cooled to −20° C. LiAlH₄ (0.567 g) was added as a powder to the reaction mixture, which was then stirred overnight. The reaction mixture was then cooled to 0° C. and quenched with ice water. The mixture was extracted with diethyl ether (3×50 mL). The combined organics were washed with water and brine, dried over MgSO₄, and filtered. After solvent removal under vacuum, the title compound (267 mg) was obtained as an orange solid.

### Example 5: Synthesis of 2-((2,3-diphenylcyclopenta-2,4-dien-1-yl)methyl)-5-methyl-1H-pyrrole (Formula 7)

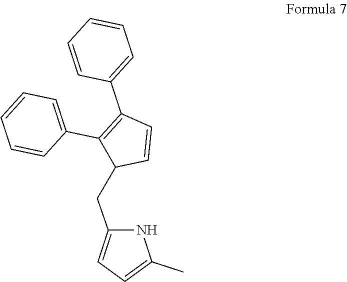 [SMILES: Cc1ccc(CC2C=CC(c3ccccc3)=C2c2ccccc2)[nH]1]

The title compound (267 mg) was obtained in a similar manner to that described for Formula 6 in Example 4, except 2,3-diphenylcyclopenta-1,3-diene was substituted for 4,5,6,7-tetramethyl-1H-indene.

### Example 6: Synthesis of 2-((1H-cyclopenta[a]naphthalen-1-yl)methyl)-5-methyl-1H-pyrrole (Formula 8)

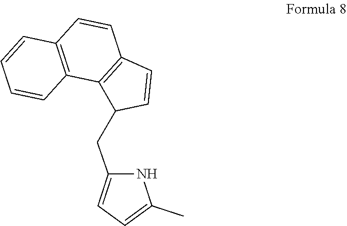 [SMILES: Cc1ccc(CC2C=Cc3ccc4ccccc4c32)[nH]1]

The title compound (594 mg) was obtained in a similar manner to that described for Formula 6 in Example 4, except 3H-cyclopenta[a]naphthalene was substituted for 4,5,6,7-tetramethyl-1H-indene.

### Example 7: Synthesis of 2-((6,6-dimethyl-1,5,6,7-tetrahydro-s-indacen-1-yl)methyl)-5-methyl-1H-pyrrole (Formula 9)

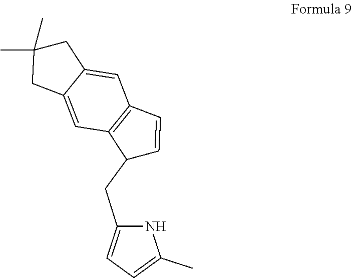

The title compound (593 mg) was obtained in a similar manner to that described for Formula 6 in Example 4, except 2,2-dimethyl-3,5-dihydro-1H-s-indacene was substituted for 4,5,6,7-tetramethyl-1H-indene.

### Synthesis of Metal-Ligand Complexes

### Example 8: Synthesis of Formula 3-Ti

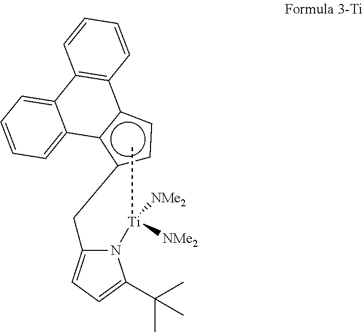

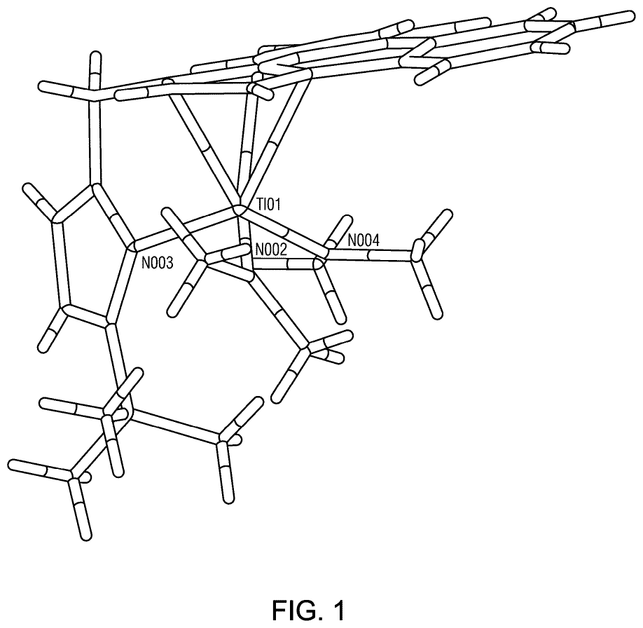

The ligand of Example 1 (180 mg) and Ti(NMe₂)₄ (115 mg) were combined in 2 mL toluene and stirred at 60° C. for 16 hours. The solvent was removed, and the remaining solids were suspended in 2 mL pentane and collected by filtration to obtain 150 mg brick red powder in 60% yield. The product was characterized by X-ray crystallography and ¹H NMR spectroscopy. ¹H NMR (400 MHz, Benzene-d₆) δ 8.60-8.47 (m, 1H), 8.23-8.13 (m, 2H), 7.93-7.85 (m, 1H), 7.37-7.18 (m, 5H), 6.79 (d, J=3.3 Hz, 1H), 6.34 (s, 2H), 6.14 (d, J=3.3 Hz, 1H), 4.66 (d, J=16.0 Hz, 1H), 4.20 (d, J=16.1 Hz, 1H), 3.01 (s, 6H), 1.41 (d, J=37.6 Hz, 15H). FIG. 1 shows the X-ray crystal structure of the metal-ligand complex having Formula 3-Ti. Other bridged metal complexes had similar X-ray crystal structures.

### Example 9: Synthesis of Formula 3-Zr

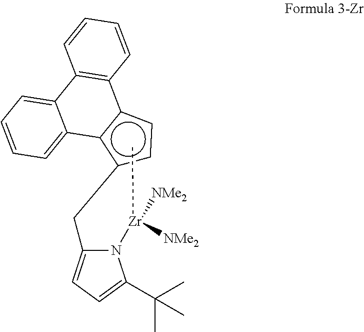

The ligand of Example 1 (50 mg) and Zr(NMe₂)₄ (38 mg) were combined in 2 mL toluene and stirred at 60° C. for 16 hours. The solvent was removed, and the remaining solids were washed with pentane until the washing was colorless. The white powder was isolated quantitatively and characterized by X-ray crystallography and ¹H NMR spectroscopy. ¹H NMR (400 MHZ, Chloroform-d) δ 8.52 (q, J=5.5, 3.2 Hz, 3H), 8.22-8.15 (m, 1H), 7.66-7.46 (m, 4H), 7.16 (d, J=3.3 Hz, 1H), 6.67 (d, J=3.5 Hz, 1H), 6.15 (d, J=3.0 Hz, 1H), 6.00 (d, J=3.1 Hz, 1H), 4.81 (d, J=16.4 Hz, 1H), 4.45 (d, J=16.4 Hz, 1H), 3.03 (s, 5H), 3.00 (s, 1H), 1.18 (d, J=20.9 Hz, 15H).

### Example 10: Synthesis of Formula 3-Hf

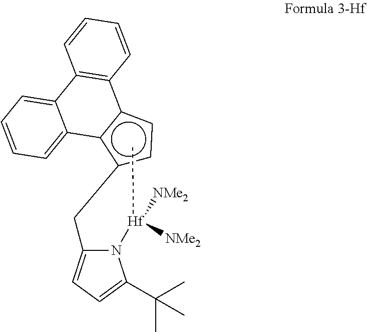

The ligand of Example 1 (192 mg) and Hf(NMe₂)₄ (194 mg) were combined in 2 mL toluene 5 and stirred at 60° C. for 16 hours. The solvent was removed, and the remaining solids were washed with pentane until the washing was colorless. The white powder was isolated in 83% yield, and characterized by X-ray crystallography and ¹H NMR spectroscopy. ¹H NMR (400 MHz, Benzene-d₆) δ 8.58 (dd, J=8.1, 1.4 Hz, 1H), 8.26-8.17 (m, 2H), 7.92-7.84 (m, 1H), 7.33-7.24 (m, 3H), 7.28-7.12 (m, 3H), 6.74 (d, J=3.3 Hz, 1H), 6.40 (dd, J=3.1, 1.3 Hz, 1H), 6.32 (d, J=3.1 Hz, 1H), 6.23 (d, J=3.3 Hz, 1H), 4.69 (d, J=16.2 Hz, 1H), 4.27 (dd, J=16.3, 1.5 Hz, 1H), 2.92 (s, 6H), 1.33 (d, J=38.4 Hz, 16H).

### Example 11: Synthesis of Formula 4-Ti

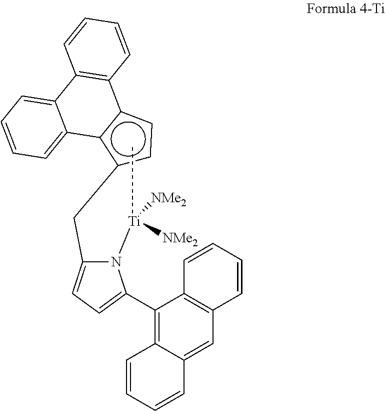

The ligand of Example 2 (181 mg) and Ti(NMe₂)₄ (86 mg) were combined in 2 mL THF and stirred at 60° C. for 16 hours. The solvent was removed, and the remaining solids were washed with 2 mL diethyl ether and 2 mL pentane and dried in vacuum to give a red powder (198 mg). The product was characterized by X-ray crystallography and ¹H NMR spectroscopy. ¹H NMR (500 MHZ, Chloroform-d) δ 8.56 (dt, J=8.0, 1.9 Hz, 2H), 8.47 (dd, J=8.0, 1.5 Hz, 1H), 8.19-8.10 (m, 2H), 7.99 (dd, J=7.7, 1.7 Hz, 1H), 7.86 (d, J=8.4 Hz, 1H), 7.76-7.63 (m, 3H), 7.47 (dtd, J=17.4, 7.2, 1.5 Hz, 2H), 7.36 (ddd, J=8.2, 6.6, 1.3 Hz, 1H), 7.29 (ddd, J=8.0, 6.6, 1.4 Hz, 1H), 7.20-7.14 (m, 1H), 7.08 (ddd, J=8.2, 6.6, 1.2 Hz, 1H), 6.65 (d, J=3.2 Hz, 1H), 6.54-6.45 (m, 2H), 6.44 (d, J=3.2 Hz, 1H), 6.23 (d, J=2.9 Hz, 1H), 4.91 (d, J=16.6 Hz, 1H), 4.59-4.51 (m, 1H), 2.60 (s, 6H), 0.73 (s, 5H).

### Example 12: Synthesis of Formula 4-Zr

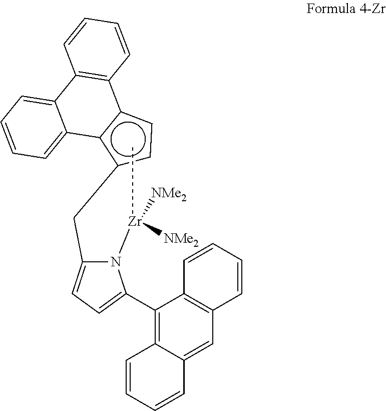

The ligand of Example 2 (108 mg) and Zr(NMe₂)₄ (61 mg) were combined in 2 mL toluene and stirred at 60° C. for 16 hours. An orange powder precipitated, and the solvent was removed. The remaining solids were washed with 2 mL diethyl ether and 2 mL pentane and dried in vacuum to give an orange powder (150 mg). The product was characterized by X-ray crystallography and ¹H NMR spectroscopy. ¹H NMR (500 MHz, Chloroform-d) δ 8.61-8.50 (m, 2H), 8.51-8.41 (m, 1H), 8.22 (s, 1H), 7.99-7.92 (m, 2H), 7.87 (d, J=8.4 Hz, 1H), 7.73 (td, J=8.4, 3.9 Hz, 2H), 7.64 (ddd, J=8.4, 7.1, 1.4 Hz, 1H), 7.44 (tt, J=7.1, 5.4 Hz, 2H), 7.36 (dd, J=8.5, 6.7 Hz, 2H), 7.32-7.25 (m, 1H), 7.14 (ddd, J=8.1, 6.6, 1.2 Hz, 1H), 6.81 (d, J=3.3 Hz, 1H), 6.78-6.66 (m, 2H), 6.52 (d, J=2.8 Hz, 1H), 6.30 (d, J=2.9 Hz, 1H), 4.91 (d, J=16.7 Hz, 1H), 4.61 (dd, J=16.7, 1.4 Hz, 1H), 2.32 (s, 6H), 0.59 (s, 6H).

### Example 13: Synthesis of Formula 4-Hf

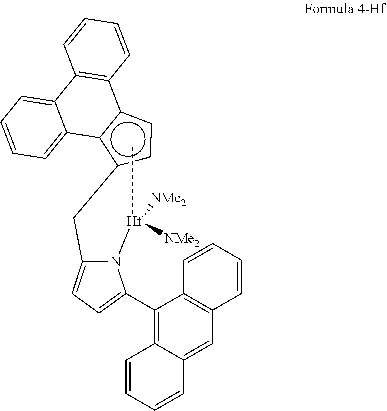

The ligand of Example 2 (102 mg) and Hf(NMe₂)₄ (77 mg) were combined in 2 mL toluene and stirred at 60° C. for 16 hours. The solvent was removed. The remaining solids were washed with 2 mL diethyl ether and 2 mL pentane and dried in vacuum to give an orange powder (112 mg). The product was characterized by X-ray crystallography and ¹H NMR spectroscopy. ¹H NMR (500 MHz, Chloroform-d) δ 8.38-8.30 (m, 2H), 8.28-8.22 (m, 1H), 8.03 (s, 1H), 7.80-7.74 (m, 1H), 7.73-7.64 (m, 2H), 7.56 (d, J=8.5 Hz, 1H), 7.55-7.47 (m, 1H), 7.43 (ddd, J=8.4, 7.1, 1.4 Hz, 1H), 7.31-7.19 (m, 3H), 7.16 (ddd, J=8.2, 6.5, 1.3 Hz, 1H), 7.13-7.06 (m, 1H), 6.95 (ddd, J=8.2, 6.6, 1.2 Hz, 1H), 6.60-6.52 (m, 2H), 6.47 (d, J=3.2 Hz, 1H), 6.36 (d, J=2.8 Hz, 1H), 6.08 (d, J=3.0 Hz, 1H), 4.76 (d, J=16.8 Hz, 1H), 4.44 (dd, J=16.8, 1.4 Hz, 1H), 2.07 (s, 6H), 0.46 (s, 5H).

### Example 14: Synthesis of Formula 5-Ti

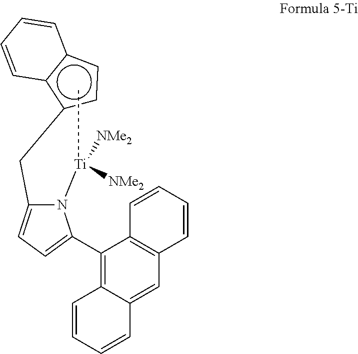

The ligand of Example 3 and Ti(NMe₂)₄ were combined in 2 mL toluene and stirred at 60° C. for 16 hours. The solvent was removed, and the remaining solids were washed with 2 mL diethyl ether and 2 mL pentane and dried in vacuum. The product was used without further characterization.

### Example 15: Synthesis of Formula 5-Zr

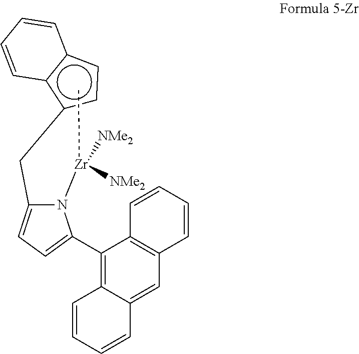

The ligand of Example 3 and Zr(NMe₂)₄ were combined in 2 mL toluene and stirred at 60° C. for 16 hours. The solvent was removed, and the remaining solids were washed with 2 mL diethyl ether and 2 mL pentane and dried in vacuum. The product was used without further characterization.

### Example 16: Synthesis of Formula 5-Hf

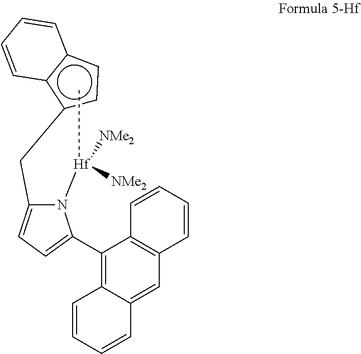

The ligand of Example 3 and Hf(NMe₂)₄ were combined in 2 mL toluene and stirred at 60° C. for 16 hours. The solvent was removed, and the remaining solids were washed with 2 mL diethyl ether and 2 mL pentane and dried in vacuum. The product was used without further characterization.

### Example 17: Synthesis of Formula 3′-Nd

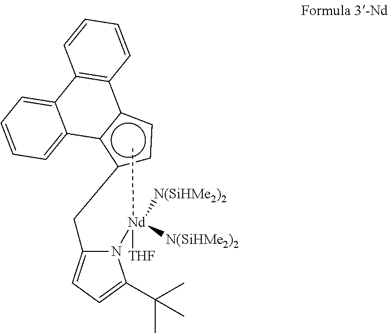

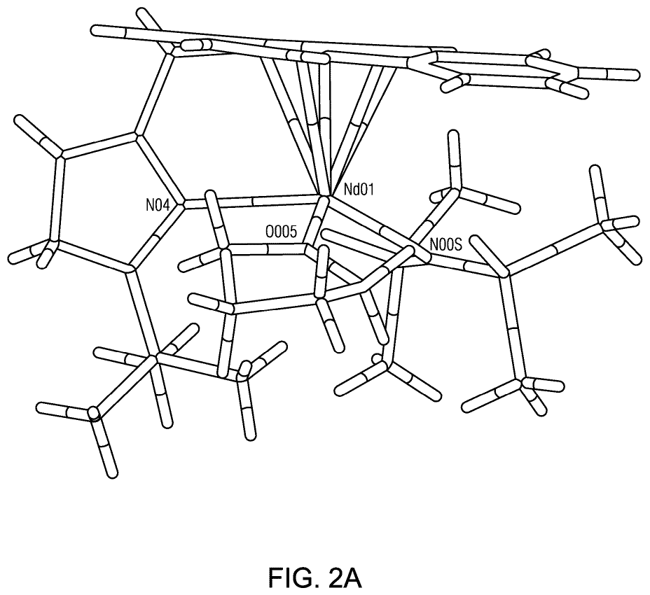

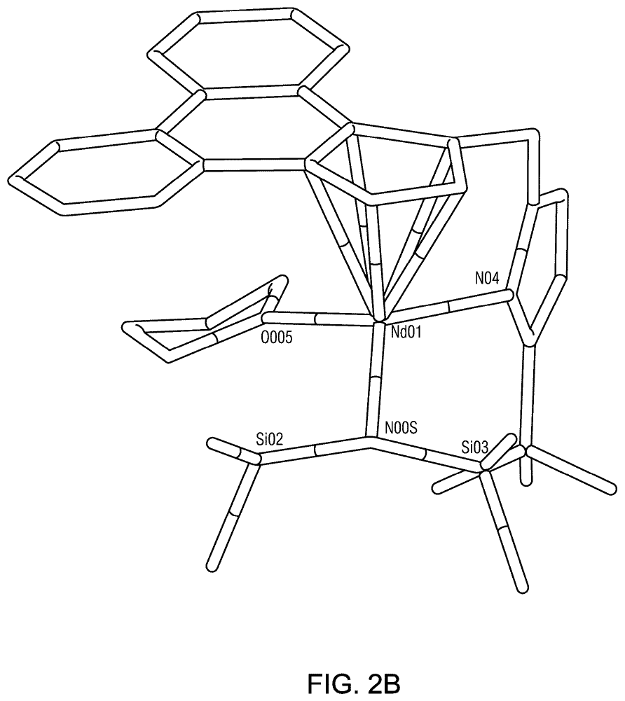

The ligand of Example 1 and Nd[N(SiHMe₂)₂]₃ (THF)₂ were combined in 4 mL toluene and stirred at 60° C. for 16 hours. The solvent was removed, and the solids were extracted into 4 mL Et₂O, filtered through Celite, and dried to give 40 mg orange powder in 40% yield. The structure was confirmed by X-ray crystallography. FIGS. 2A and 2B show alternative views of the X-ray crystal structure of the metal-ligand complex having Formula 3′-Nd.

### Example 18: Synthesis of Formula 10-La

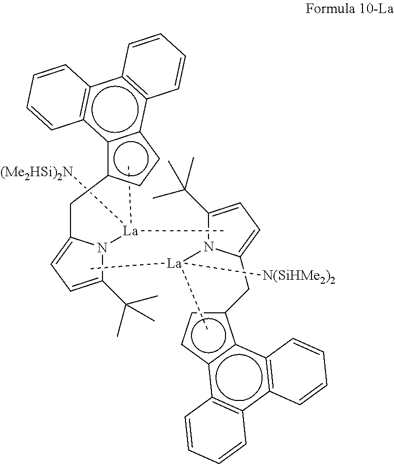

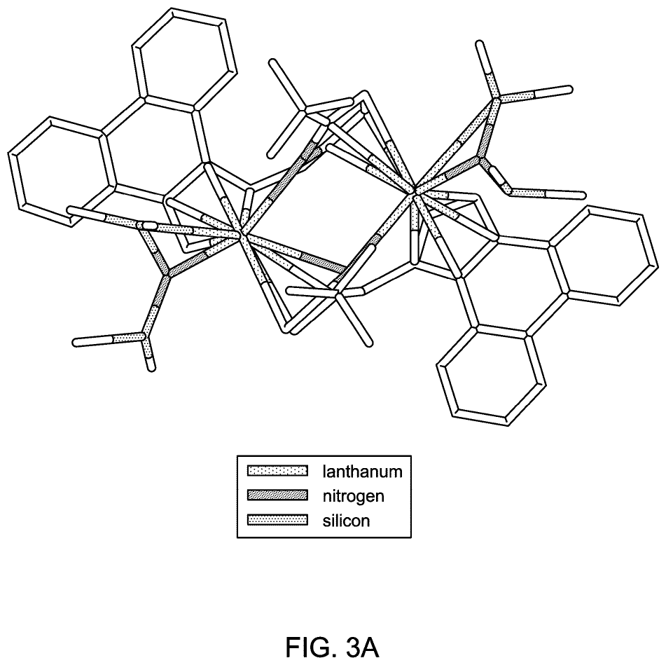

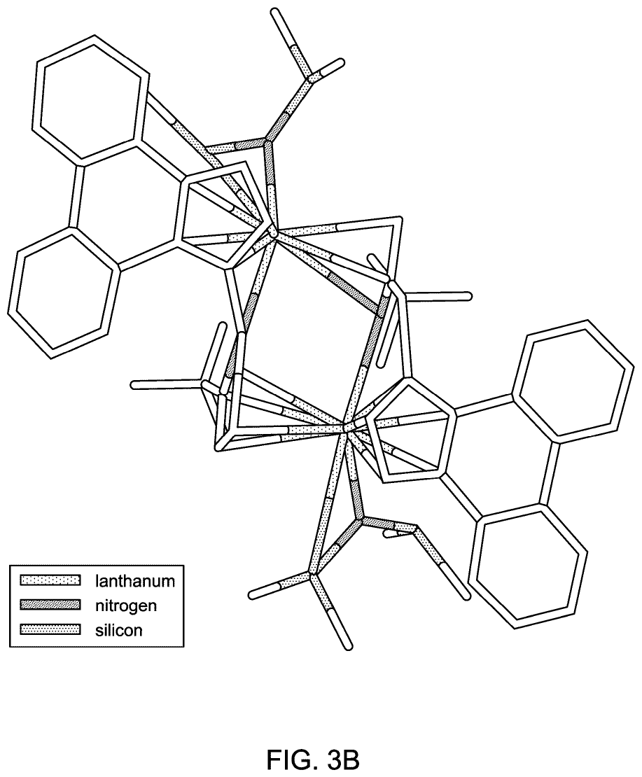

The ligand of Example 1 and La[N(SiHMe₂)₂]₃ (THF)₂ were combined in 6 mL toluene and stirred at 60° C. for 16 hours. The solvent was removed, and the solids were washed with pentane and dried. The structure was confirmed by X-ray crystallography. FIGS. 3A and 3B show alternative views of the X-ray crystal structure of the metal-ligand complex having Formula 10-La.

### Polymerization Examples

Solvents, polymerization grade toluene and/or isohexanes were supplied by ExxonMobil Chemical Company and were purified by passage through a series of columns: two 500 cm³ Oxyclear cylinders in series from Labclear (Oakland, California), followed by two 500 cm³ columns in series packed with dried 3 Å molecular sieves (8 mesh-12 mesh; Aldrich Chemical Company), and two 500 cm³ columns in series packed with dried 5 Å molecular sieves (8-12 mesh; Aldrich Chemical Company).

1-Octene (98%) (Aldrich Chemical Company) was dried by stirring over Na—K alloy overnight followed by filtration through basic alumina (Aldrich Chemical Company, Brockman Basic 1). Tri-(n-octyl)aluminum (TNOA) was purchased from either Aldrich Chemical Company or Akzo Nobel and used as received.

Polymerization grade ethylene was further purified by passage through a series of columns: 500 cm³ Oxyclear cylinder from Labclear (Oakland, California) followed by a 500 cm³ column packed with dried 3 Å molecular sieves (8 mesh-12 mesh; Aldrich Chemical Company), and a 500 cm³ column packed with dried 5 Å molecular sieves (8 mesh-12 mesh; Aldrich Chemical Company).

Polymerization grade propylene was further purified by passage through a series of columns: 2,250 cm³ Oxyclear cylinder from Labclear followed by a 2,250 cm³ column packed with 3 Å molecular sieves (8 mesh-12 mesh; Aldrich Chemical Company), then two 500 cm³ columns in series packed with 5 Å molecular sieves (8 mesh-12 mesh; Aldrich Chemical Company), a 500 cm³ column packed with Selexsorb CD (BASF), and finally a 500 cm³ column packed with Selexsorb COS (BASF).

Methylalumoxane (MAO) was purchased from Albemarle Corporation as a 10 wt % in toluene. N,N-Dimethyanilinium tetrakis(pentafluorophenyl)borate was purchased from Albemarle Corporation. All complexes and the activators were added to the reactor as dilute solutions in toluene. The concentrations of the solutions of activator, scavenger, and complexes that were added to the reactor were chosen so that between 40 microliters-200 microliters of the solution were added to the reactor to ensure accurate delivery.

Unless otherwise indicated, polymerizations were conducted in an inert atmosphere (N₂) drybox using autoclaves equipped with an external heater for temperature control, glass inserts (internal volume of reactor=23.5 mL for C₂ and C₂/C₈ runs; 22.5 mL for C₃ runs), septum inlets, regulated supply of nitrogen, ethylene and propylene, and equipped with disposable polyether ether ketone mechanical stirrers (800 RPM). The autoclaves were prepared by purging with dry nitrogen at 110° C. or 115° C. for 5 hours and then at 25° C. for 5 hours.

Polymer characterizations were conducted in accordance with the procedure set forth above.

### Ethylene Polymerization or Ethylene/1-Octene Copolymerization and Polymer Characterization

The reactor was prepared as described above, and then purged with ethylene. Toluene (solvent unless stated otherwise), optional 1-octene, and MAO (500 equivalents plus optional TIBAL-20 equivalents, specified in Tables below) were added via syringe at room temperature and atmospheric pressure in the amounts specified in the tables below. The reactor was then brought to process temperature (specified in Tables below) and charged with ethylene to process pressure (135 psig) while stirring. An optional scavenger solution (e.g., TNOA in isohexane) was then added via syringe to the reactor at process conditions. A toluene solution of the metal-ligand complex was added to the reactor via syringe at process conditions. Ethylene was allowed to enter (through the use of computer controlled solenoid valves) the autoclaves during polymerization to maintain reactor gauge pressure (+/−2 psi). Reactor temperature was monitored and typically maintained within +/−1° C. Polymerizations were halted by addition of approximately 50 psi O₂/Ar (5 mol % O₂) gas mixture to the autoclaves for approximately 30 seconds. The polymerizations were quenched after a predetermined cumulative amount of ethylene had been added or for a maximum of 30 minutes polymerization time. The reactors were cooled and vented. The polymer was isolated after the solvent was removed in-vacuum.

Analytical testing of the various polymer samples was conducted in accordance with the disclosure provided above.

Polymerization conditions and characterization data for the high-throughput polymerizations are summarized in Tables 2-14 below.

TABLE 2
Formula 3-Zr, MAO, 70° C.

Mw (g/mol)

| | | 100 μL | 200 μL | 300 μL |
|---|---|---|---|---|
| Entry | Ethylene only | 1-octene | 1-octene | 1-octene |
| 1 | 199,993 | 148,164 | 132,678 | 116,360 |
| 2 | 194,596 | 142,430 | 126,067 | 113,452 |
| 3 | 191,873 | 145,295 | 133,428 | 114,397 |
| 4 | 199,243 | 136,495 | 132,066 | 112,920 |
| 5 | 192,432 | 142,434 | 124,014 | 118,339 |
| 6 | 186,343 | 137,820 | 126,308 | 115,270 |

TABLE 3
Formula 3-Zr, MAO, 70° C.

Mn (g/mol)

| | | 100 μL | 200 μL | 300 μL |
|---|---|---|---|---|
| Entry | Ethylene only | 1-octene | 1-octene | 1-octene |
| 1 | 105,438 | 81,404 | 75,157 | 65,580 |
| 2 | 105,680 | 74,710 | 76,398 | 61,836 |
| 3 | 104,965 | 82,581 | 77,793 | 65,536 |
| 4 | 103,738 | 74,215 | 69,775 | 64,006 |
| 5 | 103,535 | 83,748 | 65,352 | 65,400 |
| 6 | 97,396 | 78,893 | 73,562 | 66,393 |

TABLE 4
Formula 3-Zr, MAO, 70° C.

| | Ethylene - | 100 μL | | 200 μL | | 300 μL | |
|---|---|---|---|---|---|---|---|
| | Only | 1-octene | | 1-octene | | 1-octene | |
| | Average | 1-Octene | | 1-Octene | | 1-Octene | |
| | Primary | Incorp. by | Primary | Incorp. by | Primary | Incorp. by | Primary |
| Entry | Tm (° C.) | IR (wt %) | Tm (° C.) | IR (wt %) | Tm (° C.) | IR (wt %) | Tm (° C.) |
| Aggregate of | 134.89 | — | — | — | — | — | — |
| Entries 1-6 from | | | | | | | |
| Tables 2 and 3 | | | | | | | |
| 1 | — | 3.9 | 124.54 | 5.6 | 117.82 | 7.8 | 114.43 |
| 2 | — | 3.3 | 123.54 | 4.9 | 118.13 | 7.0 | 112.90 |
| 3 | — | 2.9 | 123.53 | 5.7 | 117.83 | 7.8 | 113.22 |
| 4 | — | 3.3 | 123.73 | 5.6 | 117.48 | 7.2 | 113.06 |
| 5 | — | 3.4 | 123.73 | 5.9 | 117.50 | 8.4 | 112.91 |
| 6 | — | 3.5 | 123.54 | 5.0 | 117.49 | 8.3 | 112.76 |

TABLE 5
Formula 3-Zr, MAO, 70° C.

Catalyst Productivity (g polymer/mol-h)

| | Ethylene | 100 μL | 200 μL | 300 μL |
|---|---|---|---|---|
| Entry | only | 1-octene | 1-octene | 1-octene |
| 1 | 2,493,333 | 1,960,000 | 2,040,000 | 2,320,000 |
| 2 | 2,533,333 | 2,320,000 | 2,080,000 | 2,320,000 |
| 3 | 2,640,000 | 2,200,000 | 2,360,000 | 2,480,000 |
| 4 | 2,426,667 | 2,520,000 | 2,120,000 | 2,160,000 |
| 5 | 2,586,667 | 1,960,000 | 2,240,000 | 2,400,000 |
| 6 | 2,426,667 | 2,000,000 | 2,360,000 | 2,320,000 |

TABLE 6
Formula 3-Zr, MAO

| | Mw | | Mn | |
|---|---|---|---|---|
| Polymerization | Ethylene | 200 μL | Ethylene | 200 μL |
| Temperature (° C.) | only | 1-octene | only | 1-octene |
| 70 (Avg. Values | 194,080 | 129,094 | 103,459 | 73,006 |
| from Tables 2 and 3) | | | | |
| 80 | 135,228 | 102,746 | 69,286 | 53,927 |
| 100 | 86,889 | 68,005 | 44,324 | 35,415 |

TABLE 7
Formula 3-Zr, MAO

| | Primary Tm | | Catalyst Productivity | |
|---|---|---|---|---|
| | (° C.) | | (g polymer/mol-h) | |
| Polymerization | Ethylene | 200 μL | Ethylene | 200 μL |
| Temperature (° C.) | only | 1-octene | only | 1-octene |
| 70 (Avg. | 134.89 | 118.0 | 2,517,778 | 2,200,000 |
| Values from | | | | |
| Tables 4 and 5) | | | | |
| 80 | 134.9 | 116.9 | 2,398,286 | 2,176,286 |
| 100 | 133.6 | 114.5 | 2,262,667 | 2,030,286 |

TABLE 8
Formula 3-Hf, MAO, 80° C.

| | Mw (g/mol) | | |
|---|---|---|---|
| | | 100 μL | 200 μL |
| Entry | Ethylene only | 1-octene | 1-octene |
| 1 | 1,119,826 | 1,579,645 | 1,400,338 |
| 2 | 1,089,851 | 1,431,415 | ND |
| 3 | 950,749 | ND | ND |
| 4 | 926,263 | ND | ND |

TABLE 9
Formula 3-Hf, MAO, 80° C.

| | Mn (g/mol) | | |
|---|---|---|---|
| | | 100 μL | 200 μL |
| Entry | Ethylene only | 1-octene | 1-octene |
| 1 | 226,990 | 527,254 | 451,004 |
| 2 | 249,945 | 320,438 | ND |
| 3 | 218,743 | ND | ND |
| 4 | 187,698 | ND | ND |

TABLE 10

| Polymerization | | | | 200 μL | | | |
|---|---|---|---|---|---|---|---|
| Temperature = 70° C. | | | | 1-octene | | | |
| | Catalyst | Ethylene only | | | | Avg. 1-Octene | Primary |
| | (Activation | Avg. Mw | Avg. Mn | Avg. Mw | Avg. Mn | Incorp. by IR | Tₘ |
| Entry | Conditions) | (g/mol) | (g/mol) | (g/mol) | (g/mol) | (wt %) | (° C.) |
| 1 | Formula 3- | 1,485,631 | 527,108 | 1,584,616 | 685,871 | 3.8 | 123.334 |
| | Hf (MAO | | | | | | |
| | only) | | | | | | |
| 2 | Formula 3- | 1,509,677 | 615,094 | 1,378,356 | 600,896 | 4.0 | 123.639 |
| | Hf (TIBAL | | | | | | |
| | then MAO) | | | | | | |
| 3 | Formula 3-Ti | 2,260,927 | 800,625 | 1,535,400 | 556,989 | 8.4 | 118.929 |
| | (TIBAL then | | | | | | |
| | MAO) | | | | | | |

TABLE 11

| | | | | 200 μL | | | |
|---|---|---|---|---|---|---|---|
| | | | | 1-octene | | | |
| | | Ethylene only | | | | Avg. 1-Octene | |
| 80° C., MAO | | Avg. Mw | Avg. Mn | Avg. Mw | Avg. Mn | Incorp. by IR | Primary Tₘ |
| Entry | Catalyst | (g/mol) | (g/mol) | (g/mol) | (g/mol) | (wt %) | (° C.) |
| 1 | Formula 4-Ti | 932,409 | 126,871 | Insufficient Polymer | | 1.9 | Insuff. |
| | | | | | | | Polymer |
| 2 | Formula 4-Zr | 1,232,622 | 469,690 | 5,115 | 2,974 | 6.6 | 123.635 |
| 3 | Formula 4-Hf | No Polymer | | No Polymer | | No Polymer | No Polymer |
| 4 | Formula 5-Ti | 215,205 | 119,552 | 169,272 | 99,140 | 8.5 | 123.661 |
| 5 | Formula 5-Zr | 1,177,651 | 242,838 | 1,111,289 | 222,781 | 5.7 | 124.421 |

| | | | | | |
|---|---|---|---|---|---|
| 6 | Formula 5-Hf | No Polymer | No Polymer | No polymer | No polymer |

TABLE 12
Formula 3′-Nd, 70°

| | Ethylene only | 200 μL 1-octene |
|---|---|---|
| Entry | Mw (g/mol) | Mn (g/mol) |
| 1 | 1,877,919 | 1,112,479 |

Based on the polymerization data obtained, the catalyst represented by Formula 3-Zr showed the highest activity for ethylene polymerization. The Mw value produced by the catalyst represented by Formula 3-Zr was highest at a polymerization temperature of 70° C. and decreased at higher temperatures, but without significant loss of activity or co-monomer incorporation capability. Under the screening conditions with MAO, the catalyst represented by Formula 3-Hf produced higher Mw values than did to the catalysts represented by Formula 3-Ti and Formula 3-Zr. When TIBAL prealkylation was conducted, the catalyst represented by Formula 3-Ti produced a higher Mw. Co-monomer incorporation was also slightly higher under these conditions in comparison to other catalysts.

### Isoprene Polymerization

Triisobutylaluminium (185 mg) was added to a 1 mL toluene solution of the metal-ligand complex (65 mg) at room temperature. The solution was stirred for 3 minutes and triphenylcarbonium tetrakis(pentafluorophenyl)borate (86 mg) was added in one portion. After 10 minutes stirring at room temperature, 2 g isoprene was added, and the solution was left at room temperature for 16 hours. The solvents were removed from the viscous mixture, after which the solids were suspended in 10 mL diethyl ether and methanol mixture (1:1) and stirred for 30 minutes. The liquid was then decanted away from the precipitated polymer and the polymer was dried in a vacuum oven for 2 hours. NMR analyses indicated mostly predominantly cis-1,4 isoprene units. The monomer distribution in the polymer product is shown in Table 13 below. GPC analyses showed a Mw of 151,153 g/mol and a Mn of 4,286 g/mol.

TABLE 13

| Monomer Type | Mole % |
|---|---|
| cis-1,4-isoprene | 65.8 |
| trans-1,4-isoprene | 4.6 |
| 1,2-isoprene | 8.6 |
| 3,4-isoprene | 21.1 |

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

1. A metal-ligand complex comprising a transition metal atom or a lanthanide metal atom and a ligand having a structure represented by Formula 1 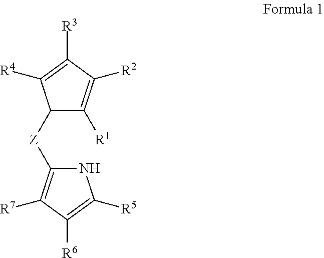
wherein:
R¹ and R² are independently hydrogen or a C₁-C₁₄ hydrocarbyl group;
R³ and R⁴ are independently hydrogen or a C₁-C₁₄ hydrocarbyl group, or R³ and R⁴ are joined together to form an optionally substituted 6-membered aromatic ring;
R⁵ is hydrogen, C₁-C₁₀ alkyl, C₃-C₁₀ cycloalkyl, C₆-C₃₀ aryl, a heteroaryl group, or CN, provided that R⁵ is C₃-C₁₀ cycloalkyl, C₆-C₃₀ aryl, a heteroaryl group, or CN if the transition metal atom is Ti or Zr and R³ and R⁴ are joined together to form a 6-membered aromatic ring, or provided that R⁵ is C₁-C₁₀ alkyl, C₃-C₁₀ cycloalkyl, C₆-C₃₀ aryl, a heteroaryl group, or CN if the transition metal atom is Ti or Zr and R¹-R⁴ are all H;
R⁶ and R⁷ are independently hydrogen or a C₁-C₁₄ hydrocarbyl group; and
Z is a bridging atom.

2. The metal-ligand complex of claim 1, wherein the metal-ligand complex has a structure represented by Formula 1A 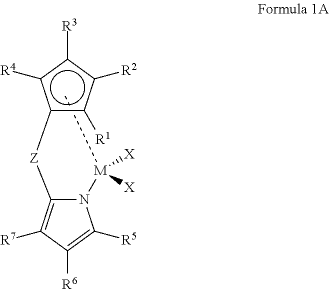
wherein:
M is the transition metal atom or the lanthanide metal atom; and
X is independently a leaving group, or two Xs are joined and bound to M to form a metallocycle ring, a chelating ligand, a diene ligand, or an alkylidene.

3. The metal-ligand complex of claim 2, wherein each X independently comprises a C₁-C₂₀ hydrocarbyl group, a hydride, an alkoxide, a sulfide, a phosphide, a halide, a diene, an amine, a phosphine, an ether, or any combination thereof.

4. The metal-ligand complex of claim 2, wherein each X is dimethylamido or bis(dimethylsilylamido).

5. The metal-ligand complex of claim 2, wherein Mis a Group 4 transition metal, a lanthanide, or chromium.

6. The metal-ligand complex of claim 2, wherein M is hafnium, chromium, neodymium, or lanthanum.

7. The metal-ligand complex of claim 1, wherein the metal-ligand complex has a structure represented by one or more of Formulas 3-5

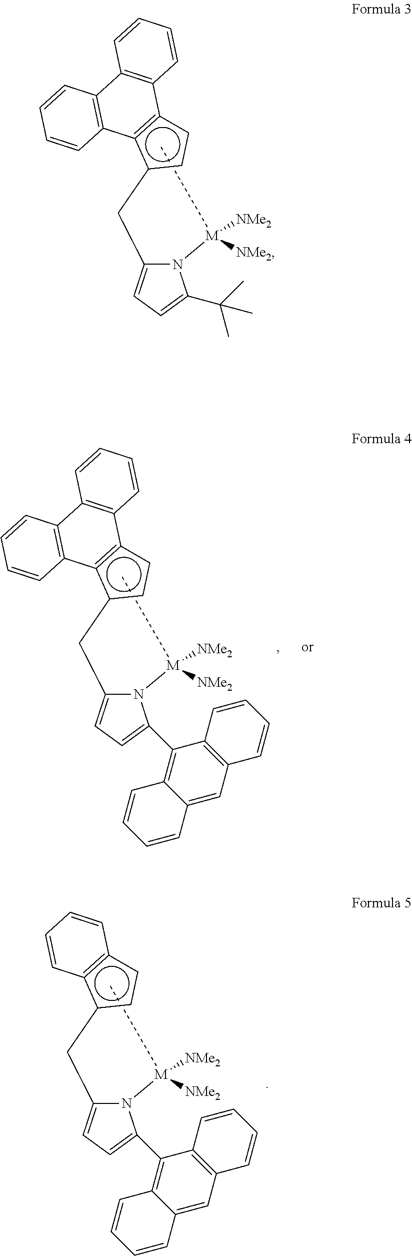

8. The metal-ligand complex of claim 1, wherein Z is CH₂.

9. The metal-ligand complex of claim 1, further comprising:
a solvent or a Lewis base complexed to the transition metal atom or the lanthanide metal atom as a second ligand.

10. The metal-ligand complex of claim 1, wherein R¹, R², R⁶, and R⁷ are independently hydrogen, C₁-C₁₀ alkyl, or C₆-C₁₀ aryl.

11. The metal-ligand complex of claim 1, wherein R¹ and R² are independently hydrogen, methyl, or optionally substituted phenyl.

12. The metal-ligand complex of claim 1, wherein R⁶ and R⁷ are both H.

13. The metal-ligand complex of claim 1, wherein R³ and R⁴ are independently hydrogen, C₁-C₁₀ alkyl, or C₆-C₁₀ aryl.

14. The metal-ligand complex of claim 1, wherein R³ and R⁴ are independently hydrogen, methyl, or optionally substituted phenyl.

15. The metal-ligand complex of claim 1, wherein R³ and R⁴ are not joined together to form an optionally substituted 6-membered aromatic ring.

16. The metal-ligand complex of claim 1, wherein R³ and R⁴ are joined together to form an optionally substituted 6-membered aromatic ring, and R⁵ is C₁-C₁₀ alkyl or C₆-C₃₀ aryl.

17. The metal-ligand complex of claim 1, wherein R⁵ is t-butyl or optionally substituted phenyl.

18. A catalyst system comprising:
at least one activator; and
a metal-ligand complex comprising a transition metal atom or a lanthanide metal atom and a ligand having a structure represented by Formula 1 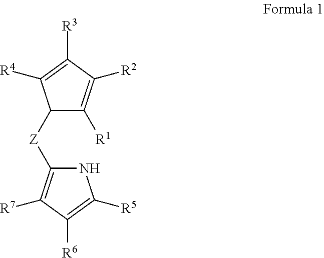
wherein:
R¹ and R² are independently hydrogen or a C₁-C₁₄ hydrocarbyl group;
R³ and R⁴ are independently hydrogen or a C₁-C₁₄ hydrocarbyl group, or R³ and R⁴ are joined together to form an optionally substituted 6-membered aromatic ring;
R⁵ is hydrogen, C₁-C₁₀ alkyl, C₃-C₁₀ cycloalkyl, C₆-C₃₀ aryl, a heteroaryl group, or CN, provided that R⁵ is C₃-C₁₀ cycloalkyl, C₆-C₃₀ aryl, a heteroaryl group, or CN if the transition metal atom is Ti or Zr and R³ and R⁴ are joined together to form a 6-membered aromatic ring, or provided that R⁵ is C₁-C₁₀ alkyl, C₃-C₁₀ cycloalkyl, C₆-C₃₀ aryl, a heteroaryl group, or CN if the transition metal atom is Ti or Zr and R¹-R⁴ are all H;
R⁶ and R⁷ are independently hydrogen or a C₁-C₁₄ hydrocarbyl group; and
Z is a bridging atom.

19. The catalyst system of claim 18, wherein the metal-ligand complex has a structure represented by Formula 1A 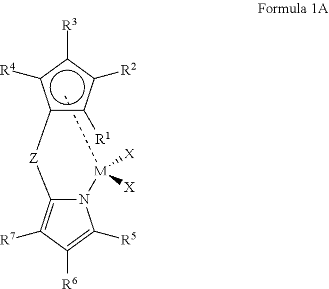
wherein:
M is the transition metal atom or the lanthanide metal atom; and
X is independently a leaving group, or two Xs are joined and bound to M to form a metallocycle ring, a chelating ligand, a diene ligand, or an alkylidene.

20. The catalyst system of claim 19, wherein each X independently comprises a C₁-C₂₀ hydrocarbyl group, a hydride, an alkoxide, a sulfide, a phosphide, a halide, a diene, an amine, a phosphine, an ether, or any combination thereof.

21.-31. (canceled)
